(19) United States
(12) Patent Application Publication
(10) Pub. No.: US 2024/0203626 A1
(43) Pub. Date: Jun. 20, 2024

(54) METHOD FOR CHARGING AND/OR DISCHARGING AND/OR REVERSING THE CHARGE OF A SUPERCONDUCTING-SWITCH-FREE SUPERCONDUCTIVELY CLOSED CIRCUIT VIA DIRECT CURRENT FEEDING, SUPERCONDUCTING-SWITCH-FREE SUPERCONDUCTIVELY CLOSED CIRCUIT FOR USE WITH SAID METHOD, SUPERCONDUCTING MAGNET AND METHOD FOR PRODUCING SAID SUPERCONDUCTING CIRCUIT

(71) Applicant: BRUKER SWITZERLAND AG, Fällanden (CH)

(72) Inventors: Davide NARDELLI, Volketswil (CH); Matteo ALESSANDRINI, Opfikon (CH)

(21) Appl. No.: 18/553,275

(22) PCT Filed: Mar. 22, 2022
(86) PCT No.: PCT/EP2022/057510

§ 371 Date: Sep. 29, 2023

(30) Foreign Application Priority Data
Mar. 30, 2021 (EP) 21166112

(51) Int. Cl. H01F 6/00; H01F 13/00

(52) U.S. Cl. CPC H01F 6/003; H01F 13/00

(57) ABSTRACT

A method for charging a superconducting-switch-free superconductively closed circuit with a sub-circuit comprising an entry connection area (6a) and an exit connection area (6b) dividing the sub-circuit into a first branch (1) with a first inductance L1 and a second branch (2) with a second inductance L2, and currents leads (3), comprising: Choosing the positions of the connection areas (6a, 6b) and/or the geometry of the branches (1, 2) and/or the cross sections of the branches (1, 2) such that the first inductance L1 is lower than the second inductance L2; modifying an initial current I0 (I0≥0) by feeding a supply current Iin into the circuit comprising: 10(a) Increasing the supply current until a first partial current in one branch reaches the critical current, (b) Further increasing the supply current to Δa resulting in a second partial current in the other branch, (c) Reducing the supply current Iin to 0A, resulting in a remanent circuit current within the circuit.

### BACKGROUND OF THE INVENTION

The invention concerns a method for charging and/or discharging and/or reversing the charge of a superconducting-switch-free superconductively closed circuit with at least one superconducting sub-circuit with a close superconducting path, at least one sub-circuit comprising an entry connection area for feeding current into the sub-circuit and an exit connection area for feeding current out of the sub-circuit, wherein the connection areas divide the corresponding sub-circuit into a first branch and at least a second branch, the first branch having a first inductance L1 and a first critical current Ic1 and the second branch having a second inductance L2 and a second critical current Ic2, and with currents leads for connecting the circuit to a power supply, wherein the method comprises electrically connecting one entry connection area and one exit connecting of the circuit to the power supply via the current leads.

The invention further concerns superconducting-switch-free superconductively closed circuits for use with the inventive method, a magnet comprising such a circuit and methods for producing the inventive circuits.

An according method to charge a closed superconducting circuit without using SC-switches is described in U.S. Pat. No. 3,546,541.

U.S. Pat. No. 8,965,468B2 discloses a method for charging a superconducting loop by direct current feeding but exploiting a standard superconducting switch concept, meaning that a branch of the closed superconducting circuit is heated to bring it close or above the critical temperature in order to make it become resistive, therefore redirecting the current to the other branch. The disadvantage of using a superconducting switch, especially in small circuits, is that it is difficult to localize the heating only in a portion of the circuit and to leave the rest of the circuit in a fully superconducting state without changing the thermal status of the entire rest of the cryogenic environment, which may comprise other superconducting elements or components in its vicinity. In fact, the power input necessary to bring the superconducting material into normal state could be not negligible, especially when dealing with the so called “high temperature superconductors”, which have a relatively high critical temperature (close or above 100 kelvin) compared to usual cryogenic temperatures employed, which range from the liquid helium temperature (4.2 Kelvin) up to 40 Kelvin and more. The problem is even heavier when more complex devices are built, e.g. comprising several loops or circuits, because the power to be supplie to the superconducting switch, which must be carried inside the cryogenic environment, is summed up, and the individual loops or circuits must be packed relatively tightly to obtain higher performances (like higher magnetic field). This means that the power to heat the superconducting switch of one of the individual loops or circuits, will influence the status of the other assembled circuits and vice-versa.

Since closed superconducting circuits are often used in cryogenic environments, e.g. as shim coils in MR magnet arrangements, another problem is that the direct current feeding transfers heat into the cryogenic system, which is undesirable because it could be critical to the rest of the system.

According coils are disclosed for example in US2019172619A1, where a coil structure of a general assembly of annular coils is shown, where no specific connections or charging methods are described. U.S. Pat. No. 4,467,303: similarly describes an assembly of ring shaped superconducting coils.

In order to avoid heat transfer into the cryogenic system, inductive coupling has been suggested (see e.g. EP2511917A1, U.S. Pat. No. 5,633,588A1, U.S. Pat. No. 8,228,148B2, US20160380526A1, Mark D Ainslie et al.). The coil to be charged is positioned in the bore of an external magnet with the desired magnetic field strength, the magnetic field is increased to the desired value and then the assembly is cooled below the critical temperature of the superconductor of the coil. Alternatively, the coil can be inserted into the bore of the external magnet, the external magnetic field is increased beyond the saturation field of the coil and the external magnet is then removed. Alternatively, the magnetic field can be generated within the bore of the external magnet, typically by pulsing the field to achieve a higher magnetic field. In this case, however, less efficient coupling with the coil is achieved, resulting in a lower and less homogeneous magnetization of the coil. In any case, inductive charging requires a high technical effort and special non-standard tools that are not yet commercial of not yet fully commercially available.

U.S. Pat. No. 6,762,664 B2 describes a method for charging superconducting disks with a pulsed magnetization method. The disks comprise several conductor elements (rings) with two contact points for connecting adjacent conductor elements. To each of the conductor elements, a transport current impulse is supplied by way of its two contact points. The transport current pulse is separated into two partial currents one through one arm of the conductor element to the other contact point and another through the other contact arm of the conductor element to the other contact point. The two contact points are so arranged that the length of the shorter of the two arms, comprises maximally 35% of the total circumference of the conductor element. In this way, a current asymmetry is established. Yet, this method has a poor efficiency.

U.S. Pat. No. 3,546,541 describes a method to charge a closed superconducting circuit without using SC-switches. For this purpose, power lines are connected to the circuit such that the circuit is divided into two branches having identical inductances, one of the branches being “strained” and then etched, and the other branch being only “strained”. The different treatments of the branches result in different superconducting current carrying capacities (i.e.: different critical currents) in the different branches.

The resulting effect is that if a current is fed into the circuit that exceeds the critical current of the first branch, a portion of the current that exceeds 50% of the current flows in the second branch and less than 50% flows in the first branch. When the current is reduced to zero, the difference between the two currents remains in the sub-circuit in persistent mode. The maximum current at which the system can be charged is limited to about the critical current Ic1 of the first branch meaning that the critical current of the second branch has to be much higher than the critical current of the first branch only for charging purpose. Thus, the known method has a poor efficiency.

### OBJECT OF THE INVENTION

It is an object of the invention to suggest a method for charging a SC-switch free circuit (charging and/or discharging and/or reversing the charge) with low technical effort but high efficiency, SC-switch free circuit for use with said charging method and a method for producing such circuits and devices exploiting such charging methods.

### DESCRIPTION OF THE INVENTION

This object is solved according to invention by charging method according to claims 1 and 2, a superconducting-switch-free superconductively closed circuit according to claim 7, a magnet according to claim 18 and a production method according to claim 19.

According to the invention, the positions of the connection areas and/or the geometry of the branches and/or the cross sections of the branches and/or the relative interaction between the branches and other elements in the neighboring environment are chosen such that the first inductance L1 of the first branch is lower than the second inductance L2 of the second branch. I.e. the invention uses a circuit having branches with different inductances.

In more complex assemblies of sub-circuits or circuits, there can be interaction among them and also with other physical elements and materials that can be into, around or, in general, in the proximity of device(s) comprising the sub-circuits or circuits (also eventually added or put on purpose to change the inductances or the features of the device), as for example adding ferromagnetic elements or other superconducting elements or whatever else that can have effects on the magnetic field distribution to enhance inductance, shield the interactions, or modify them, also eventually non-linearly as it is in the case of ferroelectric materials which saturates or superconducting materials in general.

The inductance Li of the i-th branch can be considered to be calculated more in general taking into account those interactions with a general formula:

Li=Σₗ₌₁^{N}Mᵢₗ

where N is the number of the elements/branches interacting with the i-th branch and the Mᵢₗ is the mutual inductance between the i-th branch and the I-th element/branch (Mᵢᵢ is the self-inductance of the branch considered itself)

In order to charge, discharge or, in general, to modify the remnant current circulating in the circuit, an initial current I0 (I0≥0) within the superconducting circuit is modified by feeding a supply current Iin into the circuit with the following steps:
(a) Increasing the supply current Iin until a first partial current, which passes through a branch of at least one sub-circuit, reaches the critical current of one branch,
(b) Further increasing the supply current Iin to Δa resulting in a second partial current, which passes into the other branch,
(c) Reducing the supply current Iin to OA, resulting in a remanent circuit current Icircuit within the circuit.

In step (b) the further increase of the supply current Iin causes the portion of the supply current exceeding the critical current of the first branch to be redirected into the other branch, resulting in an unbalanced current distribution (with respect to the ratio of the inductances of the two branches).

The initial current I0 is the current flowing within the circuit at the beginning of the charging or discharging process. The initial current can be zero (method starting from a discharged circuit) or unequal zero (method starting from a charged/partially charged circuit). The circuit current Icircuit is the current flowing within the circuit resulting from the charging or discharging process.

The supply current is the current fed to the circuit using the power supply.

A positive first/second partial current is said to flow from the entry connection area to the exit connection area. A positive first partial current and a positive second partial current are therefore flowing in opposite directions within the sub-circuit. According to this definition, at the end of the process the first partial current and the second partial current have the same absolute value but different signs.

Increasing the supply current means increasing the absolute value of the supply current. I.e. both for charging purposes and discharging purposes, the supply current is increased, but with different signs.

Connection areas are sections of the superconducting path to which currents leads or connecting areas of other sub-circuits can be connected.

The superconducting sub-circuit comprises at least two connection areas (a connection area being either joint to a connection area of another sub-circuit or connected to a power supply via current leads). Each sub-circuit is divided into two branches, which contact each other at their connection areas.

The superconductively closed circuit may comprise one or more sub-circuits. In case of only one sub-circuit, the sub-circuit forms the circuit. In case of more than one sub-circuit, the sub-circuits are connected at connection areas, either in series or in parallel, such that the circuit has, in the end, one entry connection area and one exit connection area to be connected with the current leads.

“SC-switch free” superconducting circuits means circuits without any superconducting (SC)-switches (which include a heating devices). A superconducting switch is typically a device made with superconducting material, typically a superconducting conductor, which comprises also a resistive heater, which heats locally or totally the switch device up to a temperature close or usually higher than the critical temperature, such to bring the device in normal state, (switch becomes a resistive element). Usually the SC-switch is part of a superconducting closed circuit (inductor). According to the invention, the circuit is SC-switch-free, thereby avoiding effort required to adequately delimit/isolate the heated area from the rest of the circuit.

The inventive method uses sub-circuits having different inductances. The inductances of the branches can be influenced by the positions of the connection areas, thereby determining the length of the branches, and/or by providing different cross-sections for the branches and/or by the design/shape formed by the branch, and/or providing interaction with different elements. The current leads connections and the geometry of paths and branches are adapted to each other in a way that asymmetrical inductance distribution, i.e. different inductances of the two branches, is achieved.

Due to the different inductances the supply current is primarily fed to the branch with the lower induction (first branch) until the critical current of one of the branches is reached. Typically, but not mandatorily, to have a more efficient circuit design in terms of compactness, charging and design efficiency, the first branch has the same critical current as the branch with higher inductance (second branch), or lower, such that the critical current of the first branch is reached first. Therefore, in this case, in step (a) the supply current is increased until the partial current, which passes through the first branch, reaches its critical current. According to the invention, the branches are supplied with current unsymmetrically/unevenly. This allows the circuit to be charged with a desired circuit current Icircuit using, for example, a standard current supply (meaning a current supply normally used to charge standard superconducting coils) but without applying any superconducting switch technology to the system. This eliminates many design and technical constraints.

Geometrical asymmetry of a sub-circuit (different lengths and/or widths, shape of the branches) is a preferred way to achieve different inductances in the different branches. The branches may (but don't have to) be made of the same superconducting material. A difference in width can lead to a difference in inductance and critical current. The sub-circuit itself may be symmetric or not. The asymmetry of the branches is achieved by choosing the position of the connection areas taking into account the geometry of the path of the sub-circuit and the required ratio of inductances. I.e. the connection areas divide the sub-circuit into the first branch and second branch such that the branches differ from each other in geometry, in particular in length and/or width and/or design (shape to which the branch is brought) of the branches or such that the branches interact with different neighboring elements. Thus, the sub-circuit itself may be geometrical symmetric, in particular axially symmetric, (e.g. circle, square shaped), but the branches are not. Special embodiments of circuits that can be provided with the method according to the invention are described below.

According to the invention, direct current feeding is used, i.e. current is fed into the circuit via current leads. No superconducting (SC) switches are used which avoids the heating of parts of the circuit and related cryogenic and design complications. The charging of the current into the circuit is neither done by induction, nor by using an inductive or magnetic method (like cooling down the circuit below the critical temperature in an externally generated magnetic field, typically with and external magnetic device able to couple with or host the circuit) and then removing the external magnetic field such that the magnetic field remains trapped in the superconducting circuit, or raising the externally generated field with the circuit already cooled down below its critical temperature and then quenching the circuit, such that the magnetic field can penetrate into the superconducting circuit and then removing the external field after the circuit temperature has come back again below the critical temperature or inducing the current by magnetic field induction like the pulsed magnetic field method.

Instead, the invention suggests a hysteretic charging method with direct current feeding using circuits having branches with different inductances thereby allowing asymmetric charging of the different branches in an effective way.

In the present description, the critical current of a superconducting element (being a branch or circuit or other elements) is defined as the current above which the material or the element passes from a pure superconducting current-carrying state (meaning: no voltage) to normal state (meaning: with voltage).

This means that the material is assumed to have a perfect steep transition (i.e. transition from superconducting state to normal conducting state), or to behave according to a typical voltage-current model relation:

(V/Vc)=(I/Ic)\hat{ }n for I≤Ic

V=I*Rns for I>Ic

where
V is the voltage developed across the considered superconducting element
Vc is the critical voltage, which is a discretional parameter chosen according to the specific application (usually 0.1 or 1 μV/cm)
I is the current passing into the element
Ic is the critical current at which V=Vc
n is the exponential value
Rns is the normal state resistivity

It means that n is considered to be infinite.

It is a theoretical assumption to simplify the description, in reality the n value is finite, but can be relatively high (30-100 as example). Therefore, the assumption can be considered relatively realistic.

Also, the persistence and decay of the current in a closed superconducting circuit is strongly related to the ratio of the operative current (current flowing inside the closed superconducting circuit) to the critical current of the superconducting element and to the n value, and the charging time of the circuit comprising the superconducting element is related to the ratio of the value of the inductance(s) in the circuit and the normal state resistance of the superconducting element(s) (Rsn).

Therefore, the critical voltage (and, therefore, the critical currents) of the superconducting elements (in particular of the first branch and the second branch) are preferably chosen to match the values, in particular of persistence and/or decay of the current and/or charging time needed for the specific application in which the present invention is employed, and the model described must be accordingly considered.

For the purpose of more easily describe the concepts, some features and parameters are defined as follows:
the circuit or subcircuit is divided, by the two connection areas (entry connection area and exit connection area). Since the current leads (main current leads) are connected to the superconducting path at connection areas, a circuit comprising only one subcircuit is divided by the two main current-leads connections into at least two branches (first branch and second branch)
h=Ic1/Ic2 where Ic1 (>0) is the critical current of the first branch and Ic2 (>0) of the second branch
k=L1/L2 where L1 is the inductance of the first branch and L2 of the second branch
Iin is the current supplied to the circuit (supply current) and ΔIin is a change, in particular one increment or decrement of it
I1 is the current flowing in the branch reaching its critical current first and ΔI1 a change, in particular one increment or decrement of it
I2 is the current flowing in another branch and ΔI2 a change, in particular one increment or decrement of it
Δa is the current fed into the circuit by the current supply during a first charging phase
−Δb is the current fed into the circuit by the current supply during a following charging phase, for changing the current in the circuit e.g. for discharging or for inverting the current, where the direction of Δb is the same of Δa (therefore, the direction of −Δb is inverted respect to Δa).
all the current values are normalized by Ic1, such that the model is generalized to any circuit (and eventually reported to the specific circuit by multiplying the currents by Ic1)

A modeling of the circuit and its behavior during the charging process is proposed here:

if h*k<1:
if |I1|<Ic1:

ΔI1/Ic1=(1/(k+1))*ΔIin/Ic1

ΔI2/Ic1=(k/(k+1))*ΔIin/Ic1
if |I1|=Ic1:

I1/Ic1=+/−1

I2/Ic1=+/−k
if |I1|>Ic1:

I1/Ic1=+/−1

I2/Ic1=+/−(Iin/Ic1−1)

if h*k>1:
if |I1|<Ic2:

ΔI1/Ic1=(1/(k+1))*ΔIin/Ic1

ΔI2/Ic1=(k/(k+1))*ΔIin/Ic1
if |I1|=Ic2:

I1/Ic1=+/−1/(h*k)

I2/Ic1=+/−1/h
if |I1|>Ic2:

I1/Ic1=+/−(Iin/Ic1−1/h)

I2/Ic1=+/−1/h

if h*k=1:
Iin is split such in a way that I1 and 12 reach exactly I1=Ic1 and I2=Ic2 at the same time, meaning that the transition from superconducting state to normal conducting state happens simultaneously for all the branches, thus preventing establishing unbalanced currents between the branches. Therefore, under this condition, it is impossible to charge the circuit.

For charging the circuit (Icircuit>I0), it is highly preferred that in step (b) the supply current Iin is increased to Δa, wherein:
Δa/Ic1>0
if h*k<1: (k+1)<Δa/Ic1≤(h+1)/h
if h*k>1: (k+1)/(h*k)<Δa/Ic1≤(h+1)/h
   with 0<k=L1/L2<1 and h=Ic1/Ic2>0 and h*k≠1

The current increase (supply current) cannot be more than the sum of the critical currents of the parallel branches of the circuit (therefore Δa/Ic1≤(h+1)/h), otherwise no part of the system is anymore in superconducting state since the transition to normal state occurs.

This situation can be eventually forced if the system is thermally stabilized enough to prevent that the power dissipated during this condition in which the circuit is in normal state conducting condition creates a quench of the circuit or, in general, an irreversible situation where the circuit is burned or the state of the circuit under charging procedure is not controllable anymore.

If, after the current is increased above the aforementioned situation, the system does not quench or burn, it is still possible to reduce the Iin to go back to ≤(h+1)/h condition and continue with the charging procedure, with no other main effects on the charging process.

On the other side, the current increase has to be high enough for the first partial current to reach the critical current of one of the two branches.

This can be obtained according to the specific parameters of the circuit:
if h*k<1: (k+1)<Δa/Ic1
if h*k>1: (k+1)/(h*k)<Δa/Ic1

A specific embodiment, which is particularly advantageous and efficient, is realized when considering h≤1 (Ic1≤Ic2), and more specifically when h=1 (Ic1=Ic2) while k->0 (L1<<L2).

In this situation, in fact, the case is:
h*k->0 (hence h*k<1): (k+1)<Δa/Ic1->1<Δa/Ic1
   meaning that it is possible to start charging the circuit already with a current Iin/Ic slightly above 1.

This is due to the fact that, due to the strong asymmetry in the inductance between first branch and second branch (L1<<L2), the current is mostly directed into the first branch, reaching the first critical current Ic1 sooner than if k is greater.

To at least partially discharge the circuit or to reverse the polarity of the current circulating in the circuit, the supply current is increased to Δb in step (b), wherein: with k=L1/L2 and h=Ic1/Ic2≤1.
Δb/Ic1>0
if h*k<1: 2*(k+1)−Δa/Ic1<Δb/Ic2≤(h+1)/h
if h*k>1: 2*(k+1)/(h*k)−Δa/Ic1<Δb/Ic2≤(h+1)/h
   with k=L1/L2<1 and h=Ic1/Ic2>0

Partially discharging the circuit means that the current within the circuit is reduced: Icircuit<I0. Reversing the polarity of the current means that the current within the circuit is reduced to zero and then increased in the opposite direction (negative values), meaning that the initial current I0 and the circuit current Icircuit flow in opposite directions. Completely discharging the circuit means charging process Icircuit=0.

As in the charging process (and with the already mentioned exceptions), the current increase (maximum value of the supply current) in the discharging process should not be more than the sum of the first and the second critical currents (therefore Δb/Ic2≤(h+1)/h).

The current increase (that is, for at least partially discharging purposes, in opposite direction of the charging current (remanent circuit current after the charging process=initial current of the discharging process) has to be high enough for the first partial current to reach the first critical current with the same sign as the initial current at the beginning of the discharging process.

The required current increase Δb depends on the specific parameters of the circuit and on the already present current circulating in the circuit (initial current), due to previous charging with Δa/Ic1:
if h*k<1: 2*(k+1)−Δa/Ic1<ab/Ic2
if h*k>1: 2*(k+1)/(h*k)−Δa/Ic1<Δb/Ic2

As in the previous case, a specific embodiment, which is particularly advantageous and efficient, is realized when considering h≤1 (Ic1≤Ic2), and more specifically when h=1 (Ic1=Ic2) while k->0 (L1<<L2).

In this situation, in fact, the case is:
h*k->0 (hence h*k<1): 2*(k+1)−Δa/Ic1<Δb/Ic2->2−Δa/Ic1<Δb/Ic2

This means that, since, as previously explained, within this conditions Δa/Ic1 can be slightly above 1 (to charge the circuit), it is possible to start discharging or reverse charging the circuit already with Δb/Ic2 slightly above 1 in the negative direction with respect to the charging case.

This is due to the fact that, due to the strong asymmetry in the inductance between first branch and second branch (L1<<L2), the current is mostly directed into the first branch, reaching the −Ic1 sooner than if k is greater.

The process can continue indefinitely, repeating with the same or inverted relative current directions, such that the remanent current circulating can be raised, diminished and/or inverted consecutively or at different times.

In case of quantum effects occurred, which for example could happen (even if not only) in case one or more dimensions of the circuit become comparable with the coherence length of the superconductor(s) used for the circuit path (meaning: approximately 1-100 times the superconducting coherence length or the superconducting penetration depth), the modification of the current circulating in the circuit (in particular charging, discharging) can be done as described in the following:

In a special variant, a circuit is provided having several sub-circuits, which are connected in parallel. I.e. at least two sub-circuits have the first branch in common, wherein the Icircuit are shared between the two or more sub-circuits by either classically splitting the current into the two sub-circuits or quantum-mechanically by superposition of the possible states Ψ₁, Ψ₂ the two or more sub-circuits, with Ψ₁=|0> or |1>, Ψ₂=|−1> or |0>, resulting in a system state Ψ_{system}=a |0 −1>+b|1 0>, where a and b depend upon the geometrical and physical properties of the two sub-circuits (if both sub-circuits are equal: a=b=1/√(2)).

To discharge the circuit according to this special embodiment (sub-circuits with common first branch), the following procedural steps are carried out prior to step (a):
a probe current Iprobe is temporarily fed in the second branch of one of the sub-circuits which is the sub-circuit under investigation via additional leads, wherein Iprobe is smaller than the critical current of the sub-circuit under investigation;
the voltage between the additional leads is measured during feeding of the probe current;
if a voltage unequal zero is detected, determine the charged current (classically) or the state (quantum-mechanically) of the sub-circuit under investigation, thereby determining the state of the whole system.

Therefore, it is possible to discharge or change the state of the sub-circuit and of the whole system by applying the method as described above to the additional leads or to the (main) current leads, too.

By sharing a branch, the sub-circuits can interact, e.g. if two sub-circuits share the first branch (charging section), the sub-circuits are charged at the same time, thus creating interaction between them.

In a preferred variant of the inventive method, the supply current is fed to the circuit using a standard power or electric signal supply by electrically connecting the current leads to the standard power supply via wire only.

Alternatively, it can be advantageous, if the supply current is fed to the circuit using a current power supply comprising in addition to a power source an internal inductor positioned in a cryogenic environment together with the superconducting circuit and a further inductor, wherein the current leads are electrically connected to the internal inductor and current is induced from the further inductor to the internal inductor and fed to the superconducting circuit via the current leads. In this case, the power supply can be partially in the room temperature environment and partially in the cryogenic environment.

Although inductors are used with this variant, the current is not induced into the circuit, but fed from the further inductor to the circuit via current leads. Rather, induction occurs within the current power supply. By feeding the external inductor with a time varying current, a current is induced in the further inductor, and is then fed into the circuit.

This enables choosing an arbitrary current strength, which is independent of the design of the circuit, but is determined by the design of the power supply (transformer).

The further inductor is preferably positioned outside the cryogenic environment.

The advantage of this variant is particularly evident whenever the current to be fed to the superconducting circuit is intrinsically too high to be transferred via current leads from room temperature to cryogenic temperature, because the transferred current would carry too much heat into the cryogenic. Example: if the circuits are made of bulk material which cannot physically/mechanically reduced in dimension below some value because of mechanical strength, the critical current would still be too high to be transferred through current leads. Generating current in a superconducting inductor inside the cryogenic environment, coupled to an external inductor magnetically solves this problem.

Alternatively, the further inductor can be positioned inside the cryogenic environment.

The supply current Iin that is fed into the circuit can be changed by using at least one of: step current ramps and/or current versus time ramps and/or high frequency pulses and/or wave packets/electromagnetic waves. A combination of the feeding methods is possible, for example, a low-frequency or constant current can first be injected to give the current in the circuit a preferred direction, and then a current ramp or pulse and/or electromagnetic wave/electromagnetic wave packet can be superimposed.

Using step current ramps, where the current is increased stepwise, is the simplest option.

When using current versus time ramps, the current is increased as a function of time (for example linear, parabolic logarithmic, or time varying function), to better control the system response (response of circuit/circuit assembly) and fit the system response to the system requirements.

When the system current must be changed quickly and the features of the system are physically compliant, it is advantageous to use high frequency current pulses interact quickly with the system.

If the dimensions of the circuit are small, or the inductance of the first branch is very small, or quantum mechanics starts to affect the system, it is possible to interact with the system using wave packets/electromagnetic waves to provide the required energy, for example to interact with a specific part of the circuit.

Further, it is possible to superpose several of the previous options: For example, it is possible to first feed some current in a step by using a current ramp to prepolarize a circuit and then superimpose pulses or wave packets to modify the response of the system, for example to achieve a preferential charging direction, or to reduce the energy required by the electromagnetic wave to charge the system.

In a special variant, prior to feeding the supply current, at least one sub-circuit of the magnet, preferably the whole circuit, is pre-heated in order to reduce the critical currents.

This allows the critical current to be reached with a lower supply current. This is particularly advantageous when the critical currents would be too high to be reached by the available supply power/currents/voltages, when there is no initial current in the circuits (I0=0) and, thus, the field generated by the system is zero or low and the corresponding critical current is higher, making the charging procedure more difficult. Reducing the critical current of the sub-circuit or of the entire circuit allows the sub-circuit/circuit to be partially charged. Thereby the magnetic field generated by the system itself is enhanced. The enhanced magnetic field in turn reduces the critical current, permitting the sub-circuit/circuit to be charged even more, which eventually permits to lower the heating temperature. By repeating this cycle, it is possible to fully charge the system at the highest possible current (field), keeping the temperature at the lowest possible value, even if initially the critical current of the system would be too high to be fed by current leads of in general, power generator or transfer lines.

The invention also concerns a superconducting circuit for use with a method according to one of the preceding claims, the circuit comprising: at least one superconducting sub-circuit with a superconducting path, wherein at least one sub-circuit comprises an entry connection area for feeding current into the sub-circuit and an exit connection area for feeding current out of the sub-circuit, wherein the connection areas divide the corresponding sub-circuit in to a first branch and at least a second branch, the first branch having a first inductance L1 and a first critical current Ic1 and the second branch having a second inductance L2, and currents leads for connecting the circuit to a power supply. According to the invention, the positions of the connection areas and/or the geometry of the branches and/or the cross sections of the branches are chosen such that the first inductance L1 of the first branch is lower than the second inductance L2 of the second branch.

The branches of the sub-circuit are preferably geometrically asymmetrical to each other, in particular have different lengths and/or widths and/or designs/shapes (geometry formed by the branches). E.g the paths of the branches may have the same length and width but form different shapes, therefore having different inductances.

In a special embodiment, the second branch has a second critical current Ic2, which is equal to the first critical current Ic1. In this variant, the charging behavior is mainly influenced by the inductances.

Alternatively, the second critical current Ic2 can be chosen higher than the first critical current Ic1. Alternatively, a sub-circuit can be provided in which the second branch has a second critical current Ic2, which is higher than the first critical current Ic1. In this variant, the charging behavior is influenced by the inductances as well as by the critical currents. In principle, the inventive idea even allows second critical current being lower than the first critical current. Crucial is that the ratio of the inductances has to be chosen sufficiently high to provide that the increase of first partial current is so much faster than the increase of second partial current that the first critical current in the first branch is achieved earlier than the second critical current in the second branch.

In a highly preferred embodiment, several sub-circuits are electrically connected in series. I.e. the circuit comprises more than one sub-circuit, wherein the exit connection area of one sub-circuit is connected to the entry connection area of the other sub-circuit, and wherein one entry connection area and one exit connection area of the circuit is connected to the current leads.

In this embodiment, the circuit comprises several series-connected sub-circuits and is charged via only two current leads carrying the current required to charge only one sub-circuit. Compared to this several circuits with only one single sub-circuit each, require as many pairs of current leads as the number of circuits.

The connection of the connecting areas of different sub-circuits can be realized by directly contacting the connection areas of adjacent sub-circuits (direct joint) or by using a bridge element (indirect joint). When assembling sub-circuits on different substrates, it may be advantageous to pass the current through non-superconducting bridging elements, since the production of superconducting joints is complicated.

In a special embodiment, the position of the current leads and/or the geometry of the branches are chosen such, that the path of the first branch of at least one of the sub-circuits, the path extending from the entry connection area to the exit connection area of the respective sub-circuit, runs at least partially in opposite direction than the path of the first branch of at least one other sub-circuit. This embodiment results in sub-circuits, which are charged in opposite direction. This enables modification of the resulting magnetic field and properties of the circuit, like for example reducing the external fringe field or localize it in some position in space, or reduce the inductance of the resulting circuit.

The relative geometrical arrangement of the sub-circuits is made as to optimize the space and/or to obtain magnetic features throughout their combinations. Therefore, it is highly preferred that several sub-circuits are nested or stacked to form a sub-circuit assembly.

A sub-circuit assembly with stacked sub-circuits has a “stacked sub-circuit design” which means the sub-circuits are arranged on top of each other (adjacent to each other in a direction oblique, especially perpendicular, to the current flowing through the sub-circuits, i.e. out of the current plane). The sub-circuits of a stacked sub-circuit design are (axially) offset (along the direction of the main component of the field that the magnet comprising the sub-circuit is designed to generate) and may have the same geometrical dimensions.

A sub-circuit assembly with nested sub-circuits has a “nested sub-circuit design” which means that the sub-circuits arranged within each other (adjacent to each other in the current plane, in particular concentrically). Nested sub-circuits are radially offset. “Nested” means that an outer sub-circuit surrounds an inner sub-circuit. A nested arrangement requires different sizes of the sub-circuits. Different “sizes” means, in particular, different diameters and or circumferences in case of ring- or curvilinear-shaped circuits, or lengths of sides of polygonal shaped circuits (like rectangles). The nested sub-circuits preferably have the same shape, e.g. circular, rectangular.

A combination of stacked and nested sub-circuits is also possible.

In case of flat or cylindrical sub-circuits, the sub-circuits can be conveniently stacked on different offset planes and/or nested in a concentric arrangement.

The circuit may comprise a single sub-circuit assembly to which a pair of current conductors is connected. Alternatively, the circuit may comprise multiple sub-circuit assemblies connected in series. An according preferred embodiment provides that several sub-circuit assemblies are provided, wherein the sub-circuit assemblies are nested, offset or side-by-side.

In a preferred embodiment, the critical currents of the sub-circuits and/or the distances between the sub-circuits change in axial and/or radial direction. This can be achieved e.g. by varying the cross sections or the superconducting properties and positioning of the paths. In particular, the cross sections and/or distances can be “graded”.

I.e.: in this embodiment, the path widths of the sub-circuits are “graded”, to account for the critical current density change due to the magnetic field change within the circuit or within a sub-circuit assembly, e.g. when it is necessary to adapt the circuit to magnetic field changes that would otherwise reduce the critical current in sub-circuits exposed to a higher magnetic field.

The higher the field, the lower is the critical current density. Thus, to obtain the same critical current for all the sub-circuit, the cross sections for the sub-circuits exposed to a higher magnetic field must be increased (or the cross section of those exposed to lower cross section must be decreased), depending to the specific properties of the superconducting material used.

More specifically, dealing with anisotropic materials such as REBCO tapes and sheets, the magnetic field intensity reduces the critical current density more when it is oriented perpendicular to the surface than when it is parallel. The magnetic field is more intense when it is closer to the axis, but it is more parallel to the axis when it is closer to the central plane.

Therefore, in case of graded path width of nested sub-circuits with magnetic field perpendicular to the surface, the path width decreases with increasing radial distance of the respective sub-circuit to the magnet center (center of the magnet field of the magnet comprising the sub-circuit). I.e. the central sub-circuit is preferably wider, because typically in a closed circuit the innermost sub-circuits are exposed to the highest magnetic field. This would compensate the decrease of the critical current of superconductor due to its intrinsic sensitivity to higher magnetic field.

In case of graded path width on flat-, rectangular- or sheet-like superconducting materials (where the geometry of the superconducting conductor has one surface wider than the other and/or the superconducting performance depends on the orientation of the field respect to the larger surface as it happens, for example, in coated conductors) of stacked sub-circuits generating a magnetic field parallel to the wider surface, the path width increases with increasing axial distance of the respective sub-circuit to the magnet center. The sub-circuits at the axial ends are larger/thicker than those in the axial central positions of the magnet. In the case of REBCO-coated conductors, for example, the superconductor carries much more current when the magnetic field is parallel to the surface (meaning that it carries more current when the field is parallel to the crystallographic ab plane (crystallographic plane of the e.g. YBCO material which is parallel to the film deposition, therefore correspond to the “flat” side of the HTS sheets) of the superconducting film). Since there are radial components at the ends of a magnet/circuit (i.e.: perpendicular to the surface of the tube), the critical current of the windings/sub-circuits at the ends is reduced. So, in this example, the sub-circuits at the ends are made larger to compensate for the loss of critical current due to the higher radial (perpendicular) component.

Alternatively, or in addition, it is also possible to use materials with different behaviors in magnet field or different materials with different behaviors in magnetic field to reduce, or eventually avoiding, the necessity of changing the cross sections of the conductors used for the circuits.

In a preferred embodiment, the sub-circuits are provided on a common carrier, in particular a sheet shaped carrier/substrate. The carrier/substrate can be made of metals or alloys like steels or Hastelloy, usually also covered with several so called “buffer layers” which are layers of various ceramic materials.

In a special embodiment, at least one sub-circuit is arranged on one surface of a circuit carrier, in particular a HTS-substrate, and at least another sub-circuit is arranged on the other surface of the circuit carrier.

In a special embodiment, the circuit comprises more than one sub-circuit, wherein at least two sub-circuits have their first branch in common, such that the initial current I0 being shared between the two sub-circuits by either classically splitting the initial current I0 into the two sub-circuits or quantum-mechanically by superposition of the possible states Ψ₁, Ψ₂ of the two sub-circuits, with Ψ₁=|0> or |1>, Ψ₂=|−1> or |0>, resulting in a system state Ψ_{system}=a |0 −1>+b|1 0>, where a and b depend upon the geometrical and physical properties of the two sub-circuits.

In particular for checking the current flow within the respective branch or to charge or discharge the circuit in a controlled way, it is preferred that the additional current leads are connected to at least one of the branches. Thus, it is possible to check the status of the individual sub-circuits and to define the status of the whole circuit and also to bring it to a predefined initial state (i.e. both sub-circuits are completely discharged), or to a predefined combination initial state even if it is in quantum state. I.e. the probabilities of the superposition of the states can be imposed. Thus, it is possible to choose which superposition should be present in the system.

In a preferred embodiment, the sub-circuits are tubular, i.e. the path of the sub-circuit form a hollow cylinder. This allows producing space-saving tubular cub-circuit assemblies.

In a special embodiment the sub-circuits of a sub-circuit assembly, in particular of the whole circuit, are a single piece of a superconductive material (superconducting unit), in particular made from a superconductive layer or a superconducting bulk material, wherein the sub-circuits are superconductively insulated from each other except for their connection areas.

This allows a very compact and advantageous serialization of the sub-circuits. In particular, the connection areas for the connection of the current leads and the current leads themselves are somehow “absorbed” in these configurations, such that they almost disappear and their impact on the device design, configuration and realization almost disappear.

The superconducting unit can be e.g. a flat, a tubular, a bulk superconductor or a superconductive coated substrate.

The sub-circuits are superconductively insulated from each other (meaning that there may still be some normal conducting electric connection), eventually with the exception of the connection areas. The insulation can be realized in particular by degradation of the material between the sub-circuits, such that it is not anymore superconducting or it is less superconducting and/or by elimination of the material between the sub-circuits and/or by substitution of material of the superconducting unit with non-superconducting material. The degradation, elimination or substitution can be realized by mechanical and/or chemical treatment.

Preferably, also the current leads are integrally formed with the circuit, in particular with the superconducting path of the circuit, (in this case the current leads are superconducting). This can be done, e.g. by laser patterning on a HTS substrate.

Alternatively, the current leads may be subsequently attached (in the latter case, the current leads may also be normally conductive).

In a special embodiment, the current leads are detachable in order to be detached after the charging procedure.

The inventive circuit can be made from different superconducting materials. Each superconducting sub-circuit comprises a superconducting path, wherein each superconducting path preferably comprises a single superconducting material. Alternatively, several different superconducting materials may be joined together to form the superconducting circuit, or the circuit may be composed of the same superconducting material but with different intrinsic superconducting properties (like different critical current densities or critical temperature or critical field). The superconducting materials may be HTS, LTS or whatever else typology (cuprate superconductors, perovkskites, pnictides, Nb3Sn and other A3B compounds, NbTi, Bi2212, Bi2223, REBCO material, YBCO, lead and alloys, other superconducting elements and compounds and alloys, in form of bulks, conductors, films or whatever else shapes and architectures which permit to realize closed superconducting circuits).

In a special variant, the first branch and the second branch are mechanically and chemically treated the same way. I.e. the circuit may be treated chemically and/or mechanically, but there is no difference in chemical and physical treatment methods between the different branches.

The invention also concerns a superconducting magnet comprising at least one superconducting circuit as described above in particular for use in magnetic resonance (MR) applications.

The circuit may comprise a single sub-circuit assembly to which a pair of current leads is connected, wherein the magnet of the invention may comprise multiple of such circuits. Alternatively, the magnet comprises a circuit with multiple sub-circuit assemblies connected in series. In the latter case, only one pair of current leads is required to power all the sub-circuit assemblies of the respective circuit.

In a special variant, at least two circuits are nested within each other.

Alternatively, or in addition, at least two circuits are stacked.

The invention also concerns a method for producing a superconducting circuit as described above, the method comprising: providing a circuit carrier, creating a superconductive path on the circuit carrier, the path forming at least one superconducting sub-circuit, providing connection areas at the sub-circuit such the superconducting sub-circuit is divided at least into branches having different inductances L1, L2, wherein the connection areas of each sub-circuit are electrically connected to connection areas of other sub-circuits or to current leads.

The carrier can be flat, bent, or have other shapes like tube or solid bulk material

In a preferred variant, the path is created by directly drawing superconducting material onto the surface of the circuit carrier. Hereby, cutting and soldering can be avoided, and less power input and an extremely compact assembly can be achieved. Drawing the circuit can be made by directly applying (e.g. depositing) the superconducting material on the areas provided for the paths or by removing/degrading the parts of a superconducting layer that must not be superconducting, leaving only the superconducting paths (like laser patterning the paths onto a fully coated superconducting sheet).

An alternative method for producing a superconducting circuit as described above comprises: providing a superconducting unit, in particular a superconductively coated substrate or a superconducting bulk material, creating a superconductive path from the superconducting unit by locally destroying or removing superconducting material from the superconducting unit, the path forming at least one superconducting sub-circuit, providing connection areas at the sub-circuit such the superconducting sub-circuit is divided into at least branches having different inductances L1, L2, wherein the connection areas of each sub-circuit are electrically connected to connection areas of other sub-circuits or to current leads.

Thus, different sub-circuits can be delimited/separated from each other starting from a superconducting unit.

Preferably, the local destruction or removal of the superconducting layer is done by scratching, etching or laser of water jet patterning. Alternatively, any other chemical and mechanical method can be used.

Preferably, at least two sub-circuits are formed, and the superconducting material is retained at the connection areas where the sub-circuits are to be superconductively interconnected.

Alternatively, at least two sub-circuits are formed, and the connection areas of the sub-circuits are electrically interconnected by bridging. Superconductive or normal conductive bridging elements can be used.

Further advantages of the invention result from the description and the drawing. Likewise, the features mentioned above and the features further specified can be used individually or in combination with each other in any desired way. The shown and described embodiments are not to be understood as an exhaustive list, but rather have an exemplary character for the description of the invention.

### DETAILED DESCRIPTION OF THE INVENTION AND DRAWING

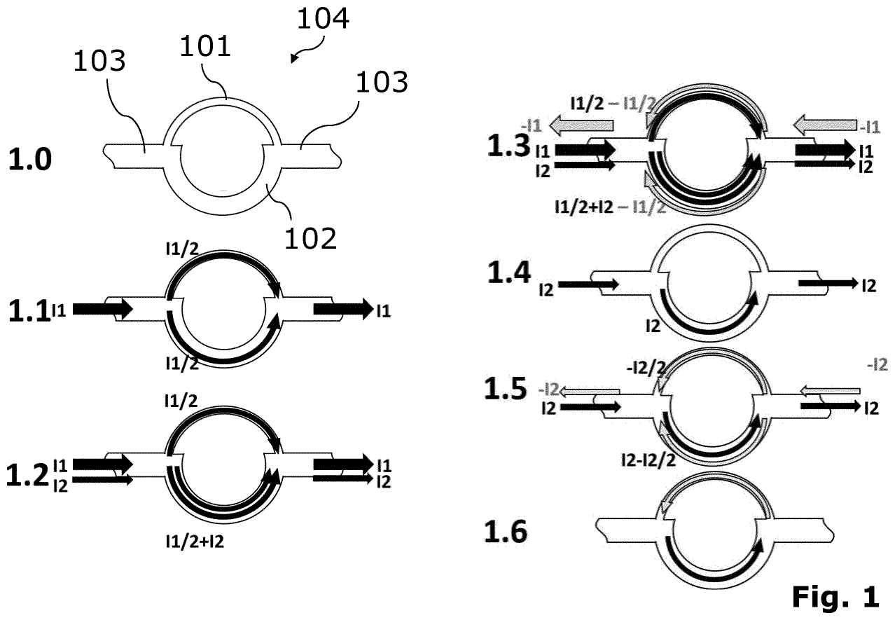

FIG. 1 shows a SC switch-free superconducting circuit with branches having different critical currents and method steps for charging the circuit.

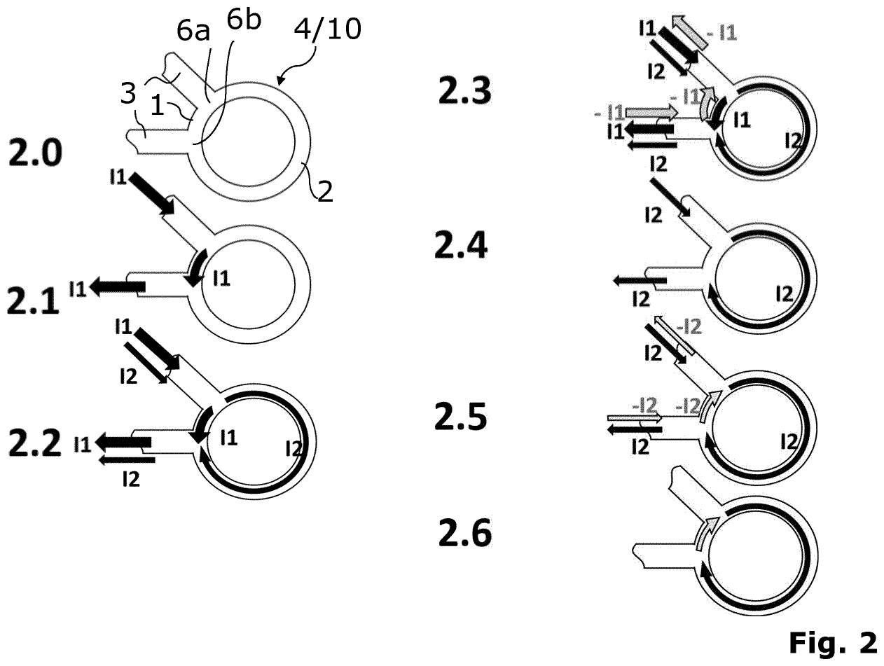

FIG. 2 shows a SC switch-free superconducting circuit according to the invention with branches having different inductances due to asymmetric current lead connection and method steps for charging the circuit.

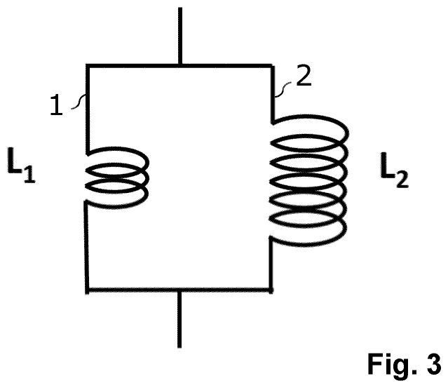

FIG. 3 shows a circuit diagram of a SC switch-free superconducting sub-circuit according to the invention.

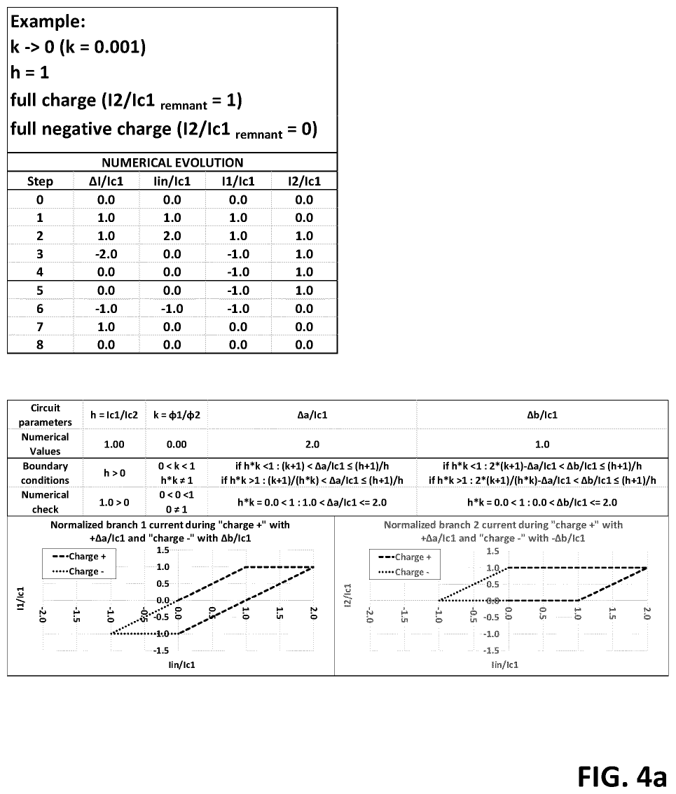

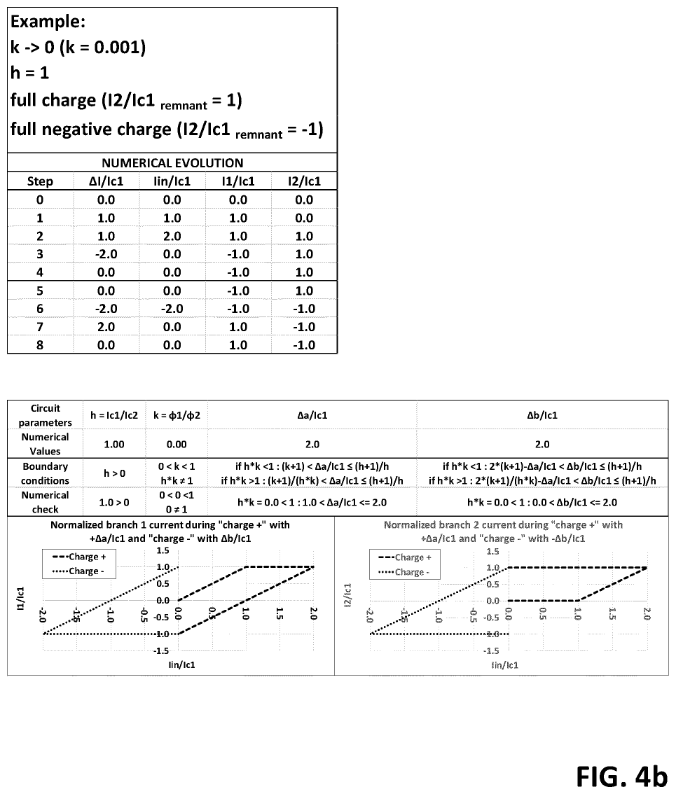

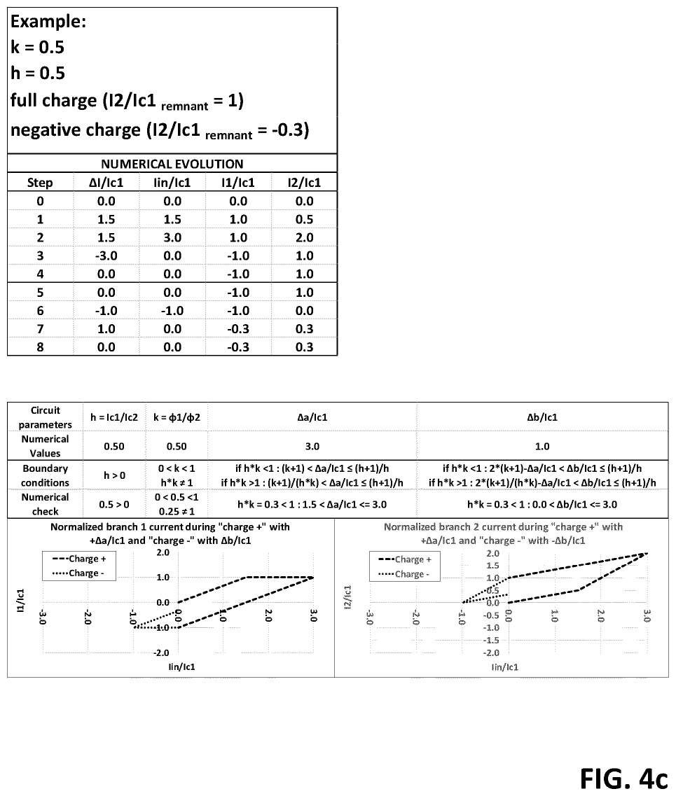

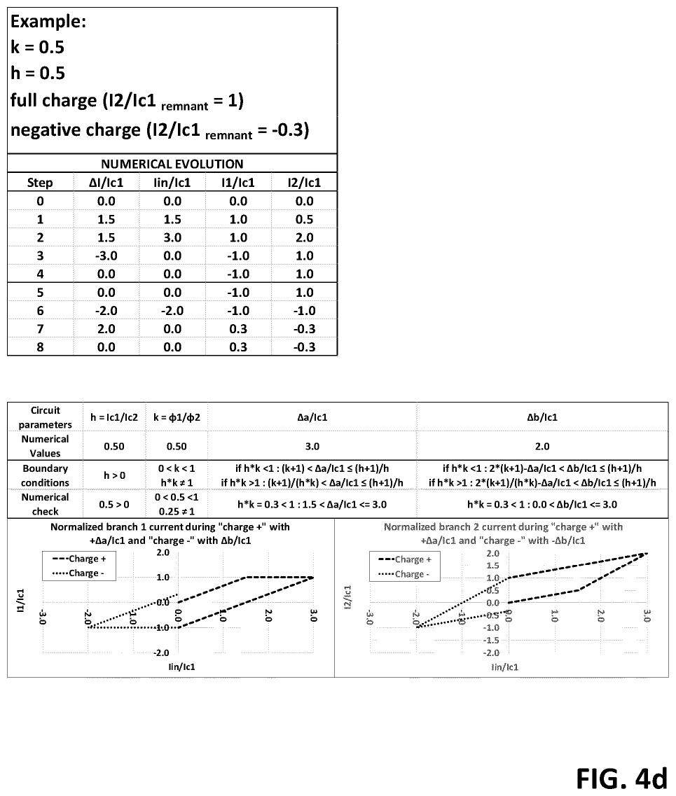

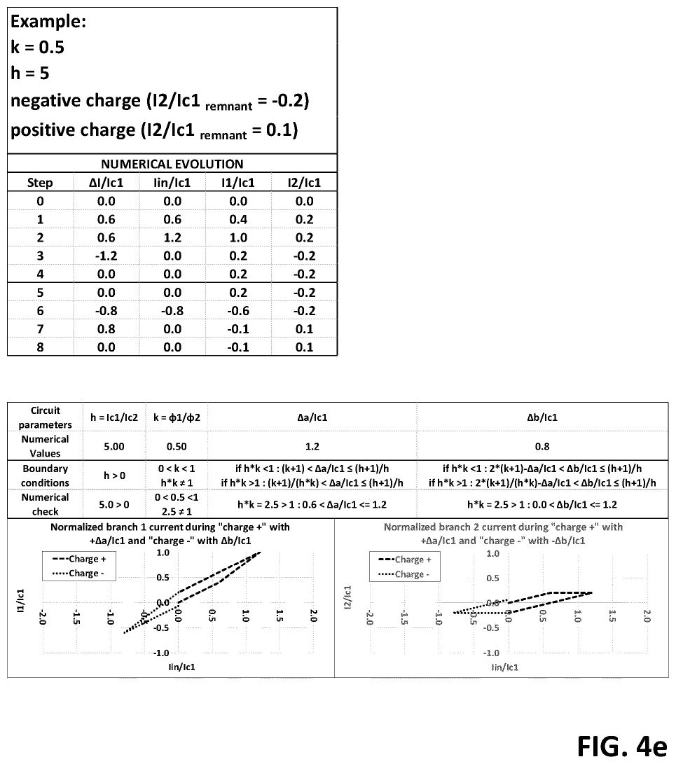

FIG. 4a-4d show diagrams of the partial currents as a function of the supply current during different variants of the inventive method (specifically with h*k<1).

FIG. 4e show diagrams of the partial currents as a function of the supply current during a variant of the inventive method (specifically with h*k>1).

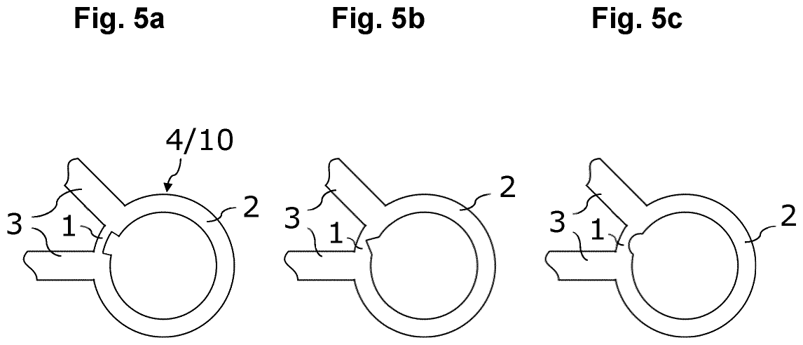

FIG. 5a-5c show SC switch-free superconducting circuits according to the invention comprising one sub-circuit with branches having different inductances and critical currents.

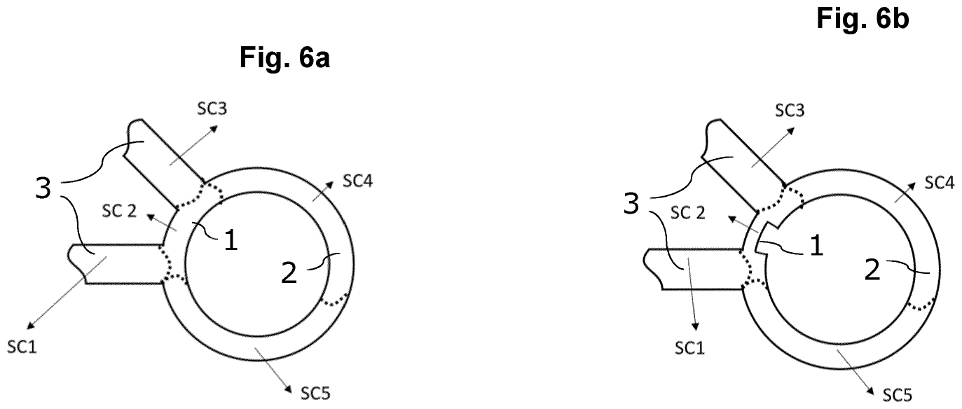

FIG. 6a-6b show SC switch-free superconducting circuits according to the invention comprising one sub-circuit with branches having different inductances due to asymmetric current lead connection and different SC material.

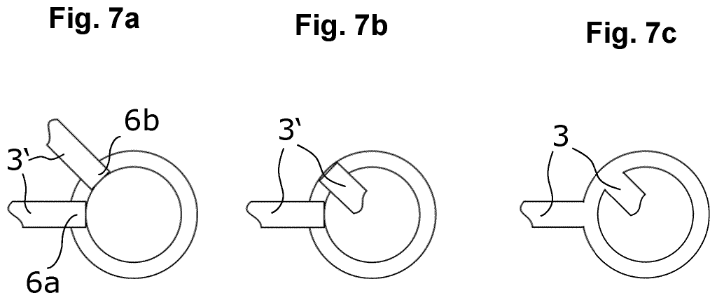

FIG. 7a-7c show SC switch-free superconducting circuits according to the invention comprising one sub-circuit with different current lead configurations.

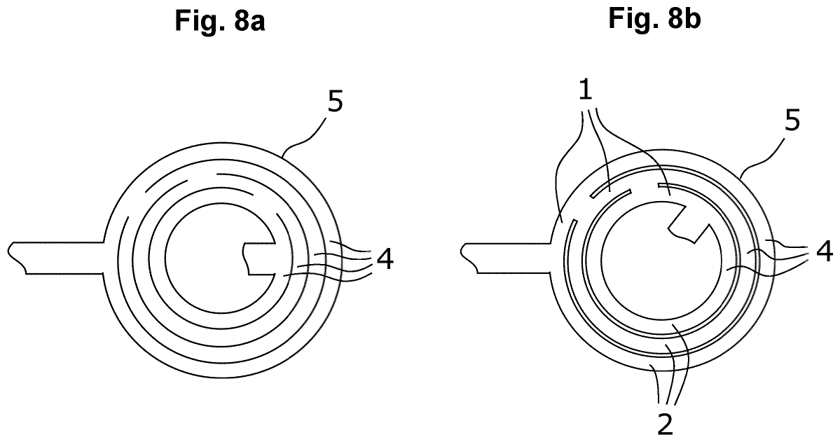

FIG. 8a-8b show SC switch-free superconducting circuits according to the invention comprising several serially connected nested sub-circuits.

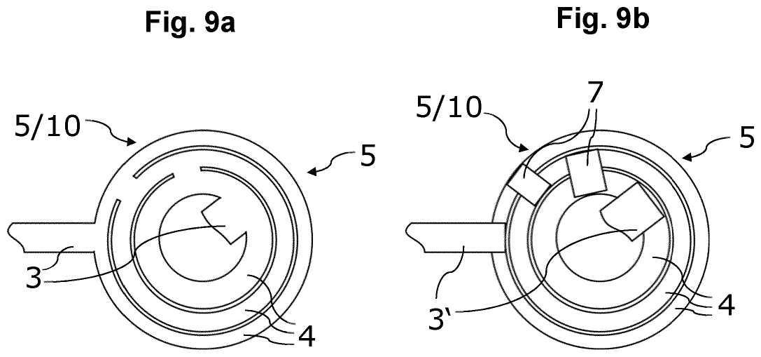

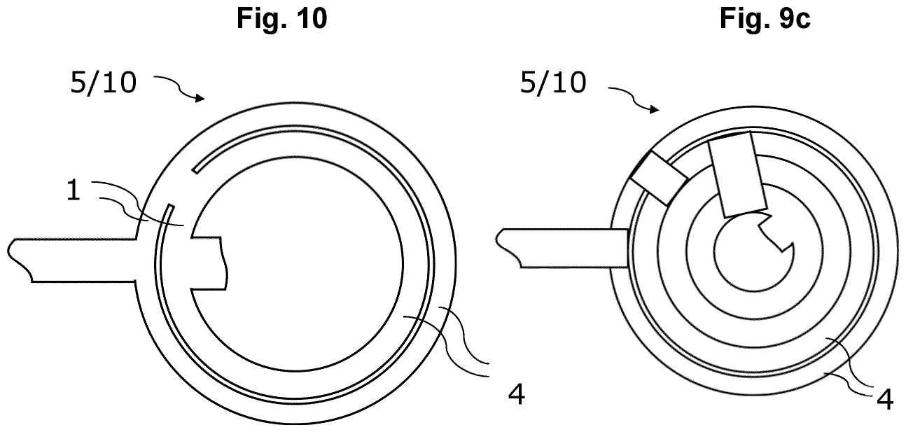

FIG. 9a-9b show SC switch-free superconducting circuits according to the invention comprising several serially connected nested sub-circuits with different path width or in general different critical currents.

FIG. 9c shows a SC switch-free superconducting circuit according to the invention comprising several serially connected nested sub-circuits, which are unequally spaced to each other.

FIG. 10 shows a SC switch-free superconducting circuit according to the invention comprising two serially connected nested sub-circuits wherein the first branches of the sub-circuits are oriented in opposing peripheral directions, thereby generating opposing magnetic fields

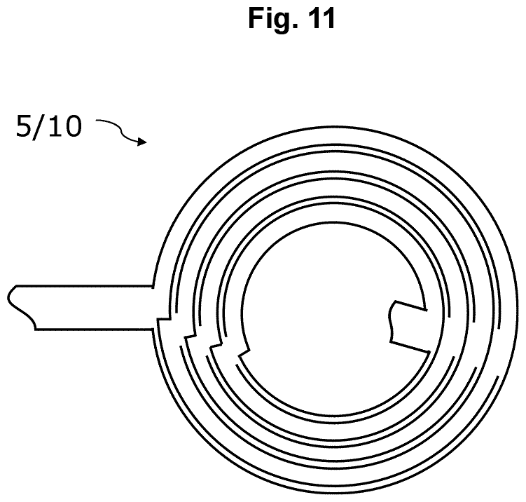

FIG. 11 shows a SC switch-free superconducting circuit according to the invention comprising several serially connected nested sub-circuits with branches having different path cross-sections.

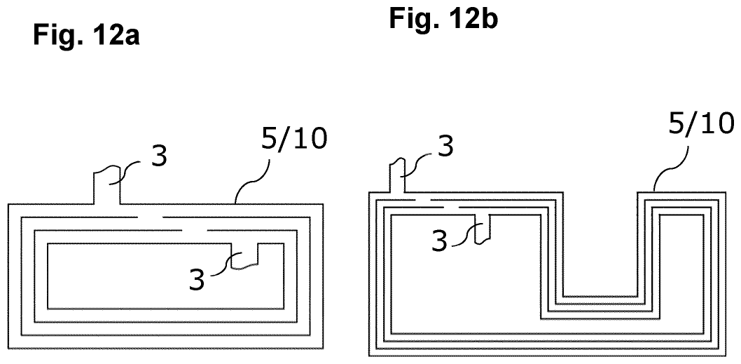

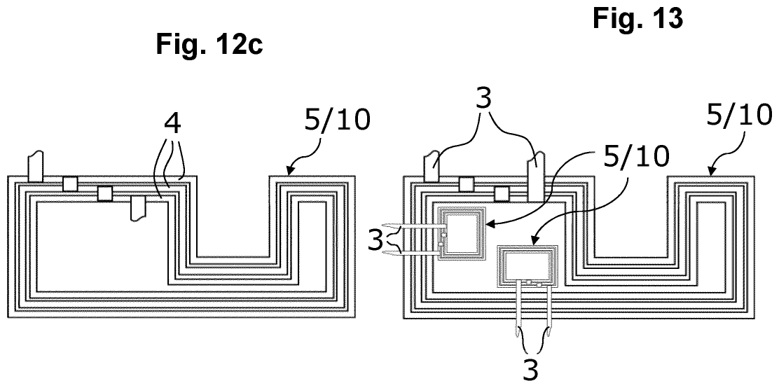

FIG. 12a-12c show different geometries of SC switch-free superconducting circuits according to the invention comprising several serially connected nested sub-circuits.

FIG. 13 show a SC switch-free superconducting circuit assembly according to the invention comprising additional circuits being nested within the circuit shown in FIG. 12c, each circuit having several serially connected nested sub-circuits.

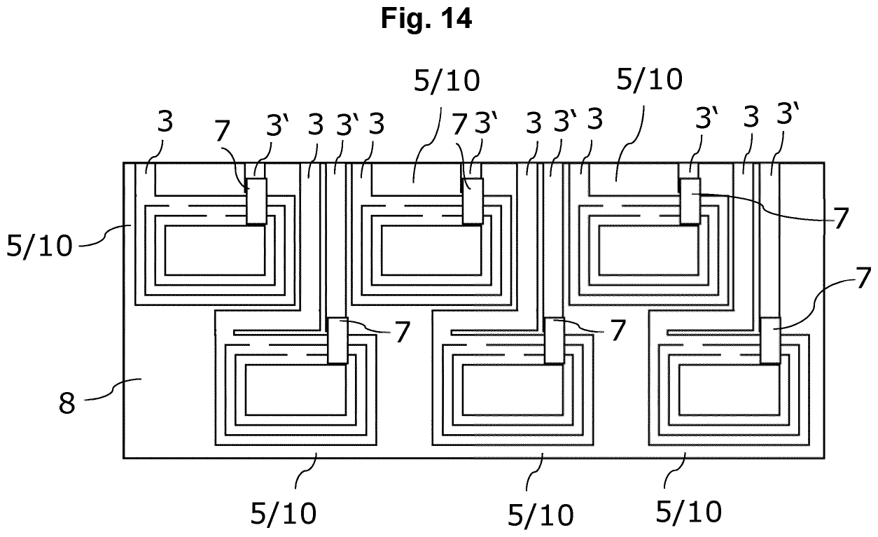

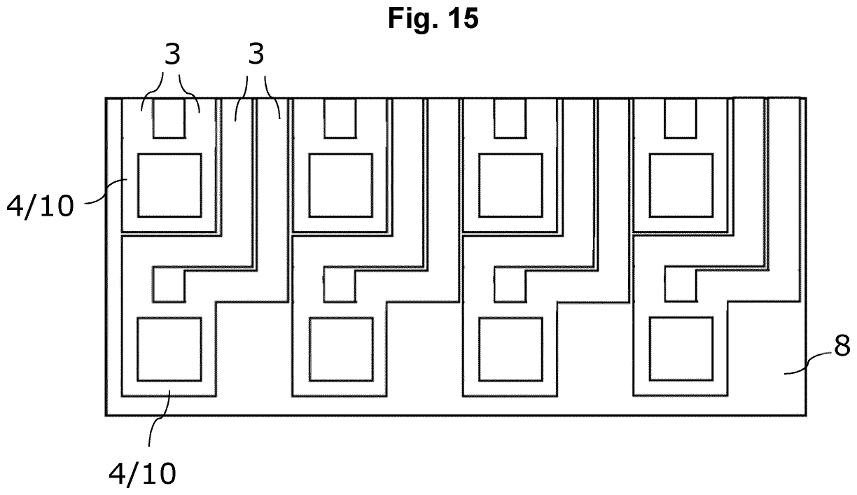

FIG. 14-16c show SC switch-free superconducting circuit assemblies comprising several circuits arranged side by side and eventually provided on a common carrier, each circuit having several serially connected nested sub-circuits.

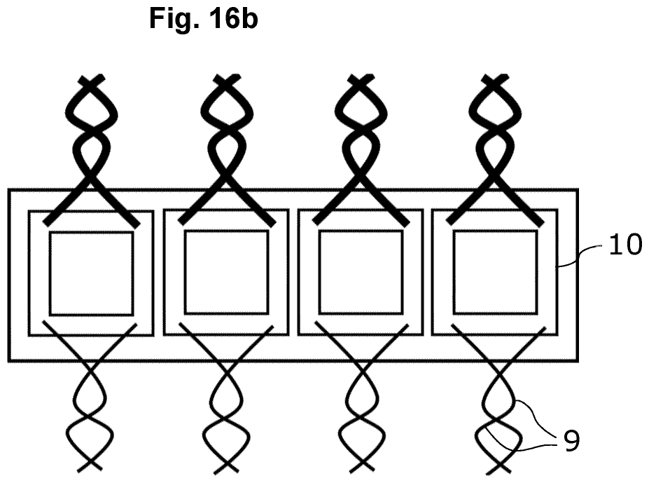

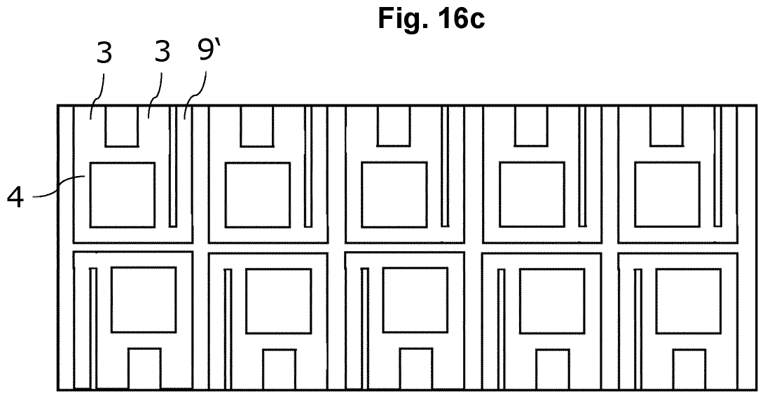

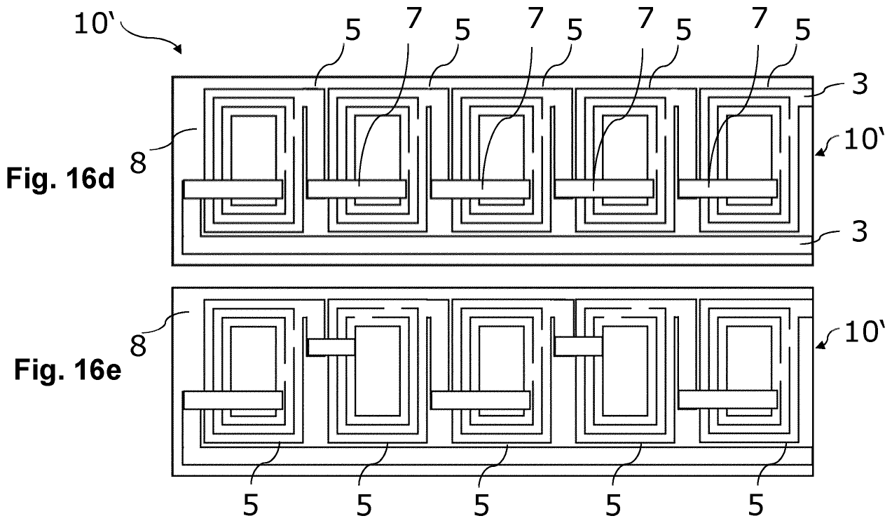

FIG. 16d-16e show SC switch-free superconducting circuits with several sub-circuit assemblies being serially connected with each other, each sub-circuit assembly having several serially connected nested sub-circuits.

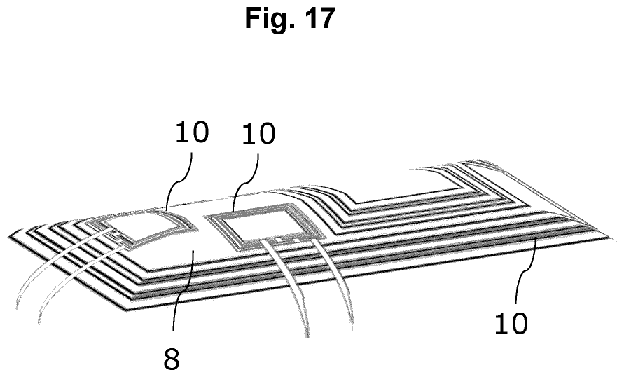

FIG. 17 shows a superconducting magnet according to the invention with the circuit-assembly shown in FIG. 13 on a bent carrier.

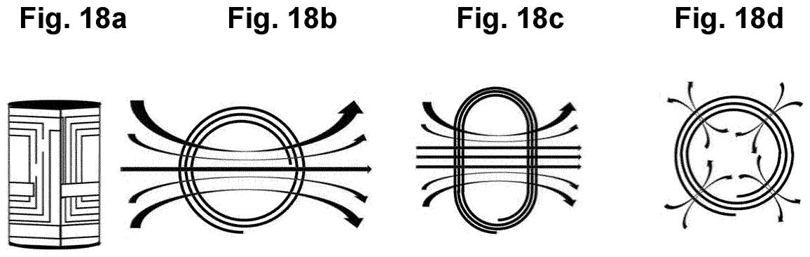

FIG. 18a-18d show different geometries of SC switch-free superconducting magnets according to the invention with a circuit according to FIG. 16d and FIG. 16e on a wound sheet like carrier and the corresponding magnetic field.

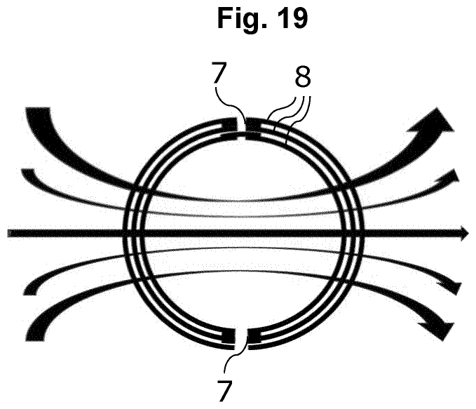

FIG. 19 shows the cross section of a SC switch-free superconducting magnet according to the invention comprising several stacked circuits on bend carriers.

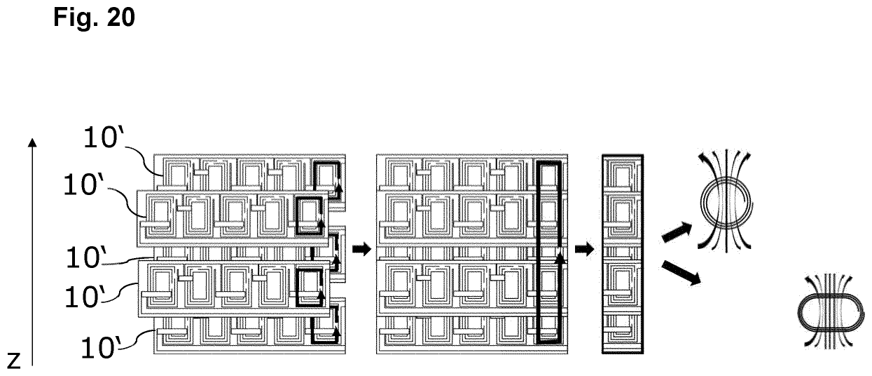

FIG. 20 show how a SC switch-free superconducting magnet according to the invention is composed of several superimposed circuits, and the corresponding magnetic field for different geometries, each circuit comprising several sub-circuit assemblies connected in series.

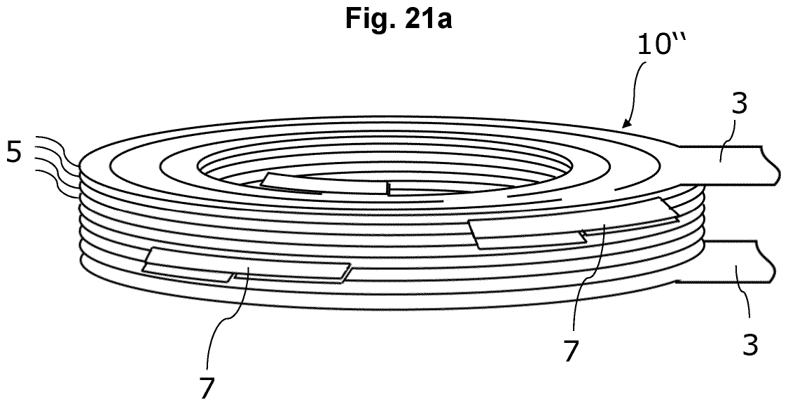

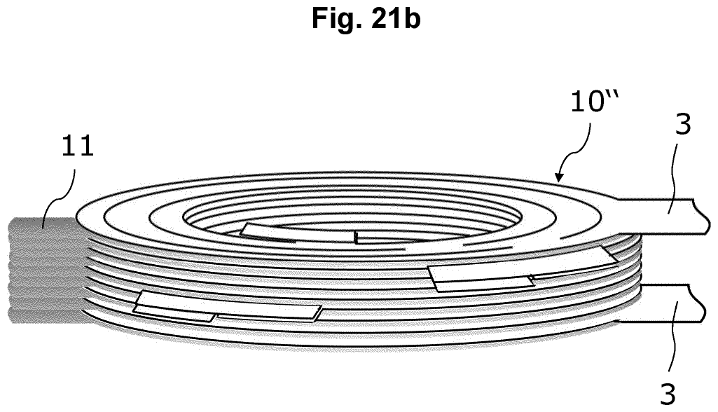

FIG. 21a-21b show SC switch-free superconducting circuit with several stacked sub-circuit assemblies, the sub-circuit assemblies having radially nested sub-circuits connected in series. The sub-circuits of each sub-circuit assembly are arranged on a flat sheet-like carrier.

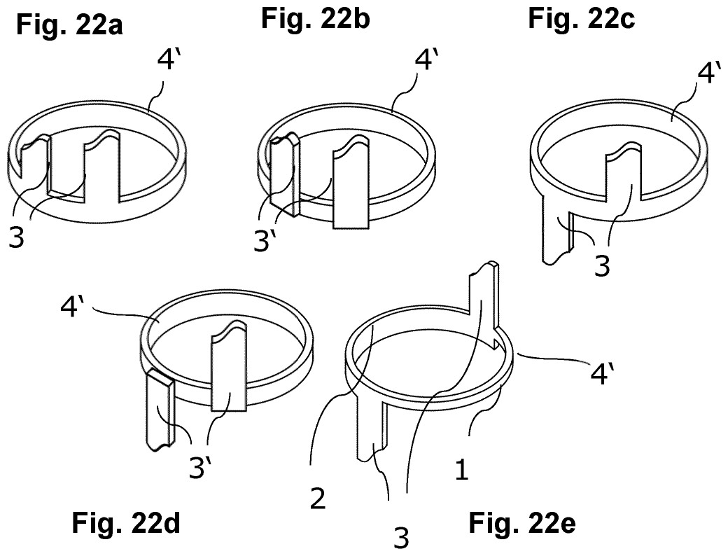

FIG. 22a-22e shows SC switch-free tubular sub-circuits.

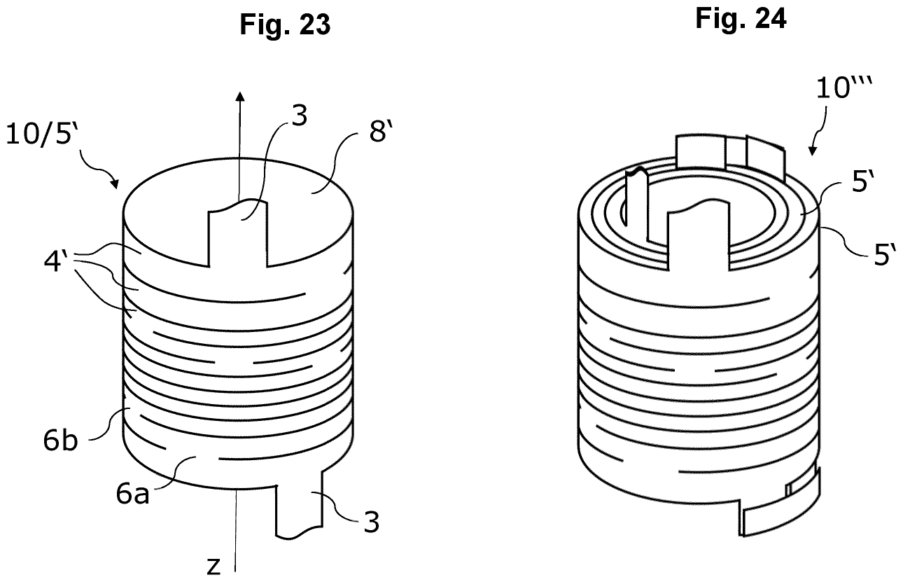

FIG. 23 shows a SC switch-free superconducting tubular circuit with stacked tubular nested sub-circuits.

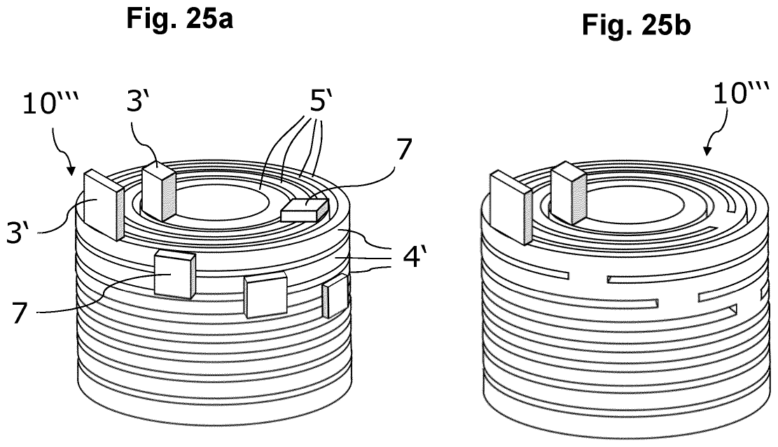

FIG. 24-25b show a SC switch-free superconducting circuit with several radial nested sub-circuit assemblies with stacked tubular nested sub-circuits. The nested sub-circuits are arranged on a ring-shaped/cylindrical carrier.

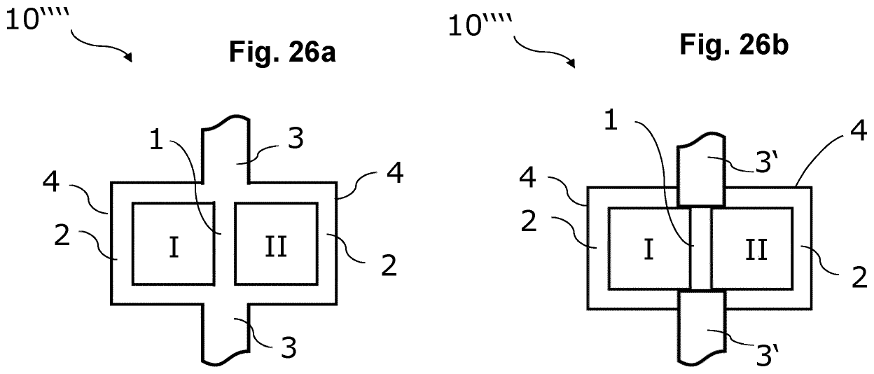

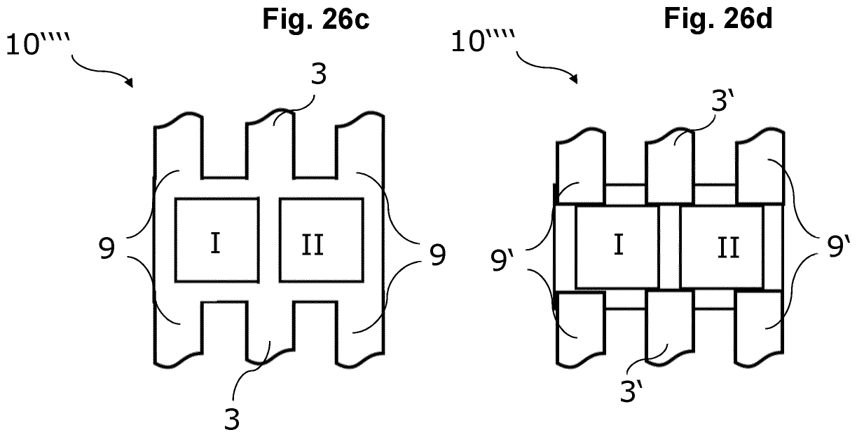

FIG. 26a-d show SC switch-free superconducting sub-circuit assemblies according to the invention with two sub-circuits, which are connected in parallel having the first branch in common.

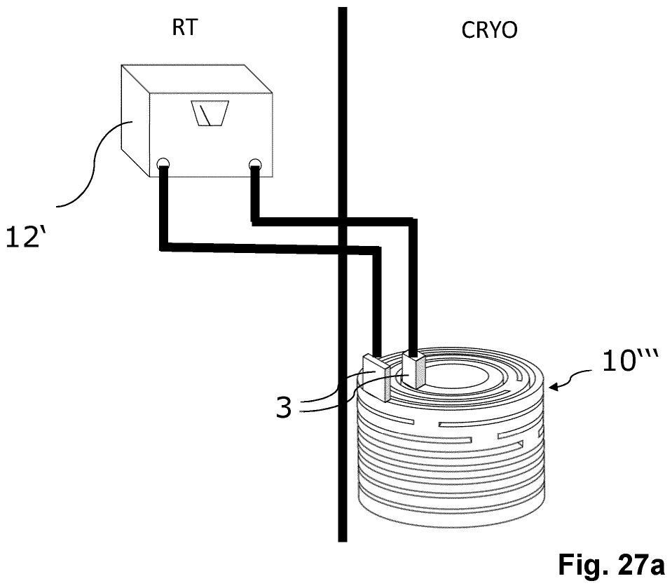

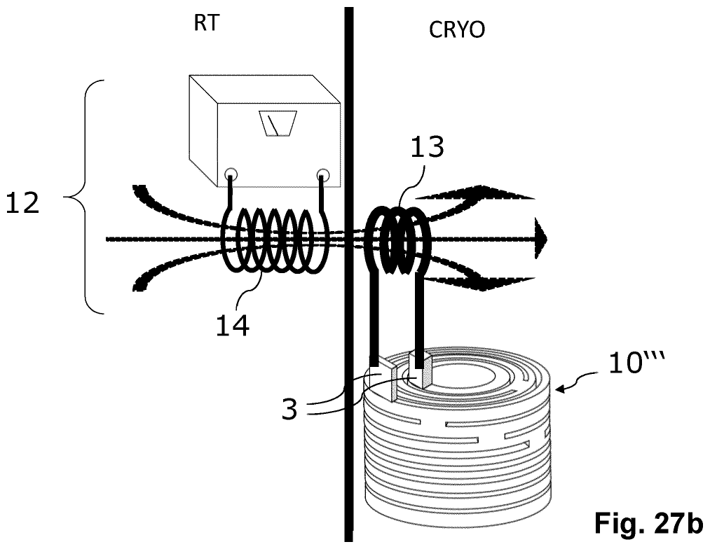

FIG. 27a shows a SC switch-free superconducting circuit according to FIG. 25b conventionally connected to a power supply via wire only.

FIG. 27b shows a SC switch-free superconducting circuit according to FIG. 25b connected to a power supply, the power supply having an external and an internal inductor.

The circuit shown in FIG. 1 comprises a first branch 101, a second branch 102 and two current leads 103. The first branch 101 and the second branch 102 form a sub-circuit 104.

The current leads are connected to the sub-circuit 104 symmetrically with respect to the length of the branches 103 but the branches 101, 102 differ in the width of the path of the branches 101, 102. The geometrical differences lead to a lower critical current Ic1 of the first branch 101 (first critical current Ic1) compared to the critical current Ic2 of the second branch 102 (second critical current Ic2).

### The Method Steps for Charging are the Following:

1.1—A supply current Iin is fed from a power supply (not shown) into the sub-circuit 4. The supply current Iin splits 50% into the first branch 101 (first partial current Ip1) and 50% into the second branch 102 (second partial current Ip2), until the first partial current reaches the critical current Ic1 of the first branch 101 (Iin=2Ic1).
1.2—The supply current Iin is further increased to (Iin=2Ic1+ΔI). Now the additional current ΔI flows exclusively in the second branch (Ip2=Ic1+ΔI), because the critical current Ic1 in the first branch 101 has already been reached.
1.3—Now the supply current Iin is reduced. Since, when reducing the supply curs rent Iin the current in both branches 101, 102 will diminish equally, the current in both branches 1, 2 are again below their critical currents Ic1, Ic2.
1.4—When the supply current Iin has been reduced by the double of the first critical current 2Ic1 (Iin=ΔI) the first partial current Ip1 is zero. Yet, in the second branch 102 a partial current ΔI still remains.
1.5—Then the supply current −Iin is further reduced until the second partial current Ip2 reaches zero. The reduced current ΔI will split equally for each branch 101, 102 resulting in a first partial currrent of −ΔI/2 and a second partial current of ΔI/2
1.6—Finally a circuit current Icircuit=ΔI/2 remains in the circuit.

The procedure can be reversed (inverse current polarity) to charge the sub-circuit with current with opposite direction or, after it is already charged, reduce the current to tune or to discharge sub-circuit 104 completely.

The maximum current with which the system can be charged is limited to about the critical current Ic1 of the first branch 101 in which the second partial current in step 1.3 is 2Ic1, meaning that the critical current Ic2 of the second branch 102 has to be much higher than the critical current Ic1 of the first branch 1 only for charging purpose, and then it is not more used. The maximum current which can remain in the circuit is limited by the lower critical current between the two branches, but it is necessary to feed up to four times that current to charge it. This requires that the critical current of the other branch must be at least three times the first one, only for charging purpose. In order to charge the sub-circuit 104 with Icircuit the supply current Iin0 Ic1+2*Icircuit of has to be fed into the sub-circuit 104 in step 1.3.

### Inventive Principle

The inventive method concerns an asymmetrical charging method where asymmetric charging is achieved by providing branches 1, 2 having different inductances L1, L2 as schematically shown in FIG. 3.

FIG. 2 shows an embodiment of an inventive SC switch-free superconducting circuit 10/sub-circuit 4 and the current distribution during charging using the method according to the invention (for a special case that the first inductance L1 is negligible to the second inductance L2 and the initial current I0=0 (FIG. 2-2.0)). The sub-circuit 4 comprises a first branch 1, a second branch 2 and two current leads 3. The current leads 3 are connected to the sub-circuit 4 at connection areas 6a, 6b (entry connection area 6a and exit connection area 6b). The branches 1, 2 are superconductively connected so that current can flow continuously in both branches 1, 2. The current leads 3 are connected to the circuit 10 in such a way that the supply current sees a parallel connection of two inductances L1, L2. According to the invention, the first branch 1 has a lower inductance L1 than the second branch 2. In the embodiment shown in FIG. 2, this is achieved by connecting the current leads 3 an asymmetrically with respect to the length of the branches 1, 2. The asymmetrical connection of the current leads 3 leads to a lower inductance L1 of the first branch 1 (first inductance L1) compared to the inductance L2 of the second branch 2 (second inductance L2), because the first branch 1 is shorter. Here, the branches 1, 2 have the same path thickness and width.

In the following it is assumed that both branches 1, 2 of the sub-circuit 4 have the same critical current Ic

The inventive charging method comprises:

Feeding a supply current Iin from a power supply (not shown) into the sub-circuit 4.
(a) Since the inductance L1 of the first branch 1 is lower than the inductance L2 of the second branch 2 an increase of the supply current Iin will generate less inductive voltage in the first branch 1 than in the second branch 2, thus the current will flow mainly in the first branch 1 until the first partial current I1 reaches the first critical current Ic1 (FIG. 2-2.1). The ratio Ip1/Ip2 of the partial currents flowing in each branch 1, 2 depends on the ration L1/L2 between the first and second inductances L1, L2.
(b) When the first partial current I1 reaches the first critical current Ic1, the supply current Iin is further increased by an additional current. Since the critical current Ic1 of the first branch 1 has already been reached and the generated voltage is able to overcome the induction voltage in the second branch 2, the additional curs rent is completely transferred to the second branch 2, the second partial current reaching I2=Iin−Ic1 (FIG. 2-2.2).
(c)—Now the supply current Iin is reduced to zero. When reducing the supply current Iin, the first branch 1 is again below its critical current Ic1. Due to the lower inductance L1 of the first branch 1, mainly the first partial current I1 will decrease (FIG. 2-2.3). The first partial current drops to zero (FIG. 2-2.4) and then changes orientation until the absolute values of the first partial current I1 and the second partial current I2 correspond to each other (FIG. 2-2.5). A remanent circuit current Icircuit then circulates within the sub-circuit (FIG. 2-2.6).

FIG. 4a and FIG. 4b show diagrams of the partial currents I1/Ic1, I2/Ic1 (normalized by Ic1) as a function of the (normalized) supply current Iin/Ic1, during this procedure for a special case where:
both branches 1, 2 of the sub-circuit 4 have the same critical current

Ic1=Ic2;h=Ic1/Ic2=1
the first inductance L1 is negligible compared to the second inductance L2 of the second branch 2

L1<<L2;k=L1/L2->0
the initial current for charging is zero

I0=0

Since for the present example it is assumed, that the first inductance L1 of branch 1 is negligible compared to the second inductance L2 of branch 2, the whole supply current is first transferred to the first branch until the partial current I1 reaches the first critical current Ic1, while the second partial current in the second branch stays zero until the first partial current reaches the first critical current Ic1.

After the first partial current has reach the first critical current the share of the supply current exceeding the first critical current Ic1 is completely transferred to the second branch 2. Here the supply current Iin is increased up to 2Ic1 resulting in a first partial current I1=Ic1 and a second partial current I2=Ic1.

Now the supply current Iin is reduced. When reducing the supply current Iin, the first branch 1 is again below its critical current Ic1. Due to the negligible inductance L1 of the first branch 1, only the first partial current I1 will decrease, drop to zero, and then invert to I1=−Ic1, while in the second branch 2 a second partial current stays I2=Ic1. Finally, a circuit current Icircuit=Ic1 remains in the sub-circuit.

FIG. 4c and FIG. 4d show diagrams of the partial currents I1/Ic1, I2/Ic1 (normalized by Ic1) as a function of the (normalized) supply current Iin/Ic1, during the inventive method procedure for a more general case where the first inductance L1 is not negligible. As an example, k is chosen to be 0.5, meaning that L1=0.5*L2.

It can be seen that in step (a) the supply current is split between the first branch 1 and the second branch 2, wherein most of the supply current is fed to the first branch 1 due to the lower inductance L1, but a not negligible part is directed to the branch 2. The supply current must be increased up to Iin=3*Ic1 to have Icircuit=1, meaning that to have the same final I circuit one must increase the supply current Iin three times compared to the previous cases (FIG. 4a and FIG. 4b). This means that the second branch 2 must have two times the critical current compared to the first branch 1. In other words, the higher is the ratio k, the higher is the current which must be provided to the circuit to be charged, and the higher must be the difference between the critical current of the two branches to enable the full charge of the circuit, which means that the design is less efficient.

An even less efficient situation (albeit still possible) is shown in FIG. 4e, where k is still 0.5 but h=5 (meaning that the Ic1=5*Ic2>Ic2).

In this case, the situation is complicated as the transition to the normal state of the second branch 2 occurs prior to that of the first branch 1, therefore redirecting the current into the first branch 1. At the end of the charging process, the remanent current Icircuit remaining in circulation will have an opposite direction with respect to the cases previously presented.

In case the initial current within the circuit is unequal zero (I0≠0) the inventive method can also be used to reduce, to reverse the current within a circuit or to completely discharge the circuit:
(a) The supply current is increased (with polarity of the initial current in the first branch 1) until the first partial current I1 reaches the first critical current Ic1 (with polarity of the initial current Iin in the first branch 1). Again, since the inductance L1 of the first branch 1 is lower than the inductance L2 of the second branch 2, an increase of the supply current Iin will generate less inductive voltage in the first branch 1 than in the second branch 2, thus the current will flow mainly in the first branch 1 until the first partial current I1 reaches the first critical current Ic1. The ratio Ip1/Ip2 of the partial currents flowing in each branch 1, 2 depends on the ration L1/L2 between the first and second inductances.
(b) When the first partial current I1 reaches the first critical current Ic1, the supply current Iin is further increased by an additional current. Since the critical current Ic of the first branch 1 has already been reached and the generated voltage is able to overcome the induction voltage in the second branch 2, the additional current is completely transferred to the second branch 2. Since the second partial current I2 at the beginning of the discharging procedure has opposite polarity than the first partial current I1 and the supply current, the second partial current I2 is reduced due to the increase of the supply current Iin.
(c) As soon as a desired value for the second partial current I2 is reached the supply current Iin is reduced to zero. When reducing the supply current Iin, the first branch 1 is again below its critical current Ic1. Due to the lower inductance L1 of the first branch 1, mainly the first partial current I1 will decrease. The first partial current I1 drops until the absolute values of the first partial current I1 and the second partial current I2 correspond to each other. A circuit current Icircuit is obtained within the sub-circuit 4, which is smaller than the initial current I0 or has opposite orientation than the initial current I0.

In FIG. 4a complete discharging is shown, i.e. Icircuit=0, while in FIG. 4b a full negative charging is shown (I circuit=−1)

Compared to the prior art method shown in FIG. 1, the inventive concept can make better use of the superconductor material and available space, since the branches 1, 2 of the sub-circuit 4 can have the same critical current. This means that with the inventive method, circuits can be charged with a higher current than circuits having non-uniform critical currents while using the same supply current Iin. This allows for more compact and powerful (and possibly cheaper) magnets.

The efficiency for an optimized designed is limited by the ratio L1/L2 of the inductances of the two branches 1, 2. In order to be able to fully charge (maximum remanent current) the circuit (whenever required), the circuit must therefore be designed with a defined Ic1/Ic2 ratio (as it has been shown in the examples above and implied by the aforementioned equations which describe the circuit behavior).

So, if the efficiency “e” of a circuit design for this application is defined as the ratio between the maximal remanent currentI circuit, which can be charged in the circuit (which corresponds to the minimum of the critical currents Ic1 and Ic2, otherwise the current decays to the lowest one), and the maximal critical current needed to permit full charge of the circuit.

In an optimized design, to maximum current that can be charged in the circuit is 2 times the current necessary to start charging the circuit, because that is the lower critical current among the branches and, therefore, the one that limits the persistent current, which can circulate.

If h*k<1:
in (k+1)<Δa/Ic1≤(h+1)/h (one equation of boundaries mentioned in the “Description of the invention”) it is necessary to impose Δa/Ic1=2*(k+1), where (k+1) is the minimum value to start charging the circuit. But, to consider an optimized circuit, this value must correspond also to the maximum value that can be fed in the circuit to avoid going above the transition of the whole circuit, meaning:

2*(k+1)=(h+1)/h
this equation leads to the condition:

e_{optimized}=h=1/(2*k+1)

if h*k>1:
following the same approach as above, in (k+1)/(h*k)<Δa/Ic1≤(h+1)/h (one equation of boundaries mentioned in the “Description of the invention”)

2*(k+1)/(h*k)=(h+1)/h
meaning that:

e_{optimized}=1/h=k/(k+2)

To evaluate the efficiency in circuit design, for example, it is possible to consider the two extreme situations (special cases):

k=1 corresponding to the situation where L1=L2

if h*k<1:e_{optimized}=1/3=Ic1/Ic2

if h*k>1:e_{optimized}=1/3=Ic2/Ic1

k->0 corresponding to the situation where the L1 is negligible respect to L2

if h*k<1:e_{optimized}->1=Ic1/Ic2->Ic1=Ic2

if h*k>1:e_{optimized}->0 not interesting!

The case with k=1 is fairly less advantageous respect to k<1 and, especially, when k->0.

Even if the circuit does not need to be fully charged up or close to the critical current value, it is anyway advantageous to have an optimized circuit design because the same current can be charged in an optimally designed circuit at a lower ratio of (Icircuit/Ic) compared to a non-optimally designed circuit.

This is important, as explained previously, because the voltage in the circuit depends on the ratio Ioperative/Ic, and the lower is the voltage, the lower is the dissipation and the longer is the persistence of the current in the circuit.

The sub-circuit 4 shown in FIG. 2 can be a very basic embodiment of the inventive circuit 10. However, the circuits 10, 10′, 10″, 10″′, 10″′ according to the invention can also be more complicated. The sub-circuits 4 may be elongated and have different shapes and may be made of different superconducting materials and/or shapes or material compositions, provided that they comprise superconducting material that forms a closed superconducting path and can be charged according to the principle described above.

The inventive charging method can be combined with the charging method shown in FIG. 1, meaning the branches 1, 2 differ not only in inductance but also in critical current. This can be realized by providing an asymmetrical current leads 3 connection with respect to the length of the branches 3 and additionally branches having different path thicknesses. Examples are shown in FIG. 5a, FIG. 5b and FIG. 5c.

Furthermore, the circuits/sub-circuits can be made of different superconducting materials or of superconducting materials with different physical properties such as critical current density, critical temperature, irreversible field, etc., provided that a closed superconducting circuit is provided with branches having different inductances. Examples are shown in FIG. 6a and FIG. 6b, in which the first branch 1 is made of superconducting material SC2 and the second branch 2 is made of superconducting materials SC4 and SC5. In the embodiment shown in FIG. 6b, the first branch 1 additionally has a reduced path width. In addition, the current leads 3 can be made of different superconducting materials SC1, SC3. Yet, there are also embodiments possible where the current leads 3 are not superconducting. The connection between the circuit 10 and the current leads can be superconducting or normal conducting as long as the sub-circuit 4 of the circuit 10 itself remains superconducting.

Current leads 3, 3′ can be connected in different directions as long as the position of the connection areas 6a, 6b respect the geometry, which is necessary for providing branches 1, 2 with different inductances, i.e. asymmetric current lead connection.

FIG. 7a, FIG. 7b and FIG. 7c show different geometries for current lead connection variants. FIG. 7a shows current leads 3′ directed outward, wherein in FIG. 7b and FIG. 7c one of the current leads 3, 3′ is directed towards the center of the sub-circuit. The current leads 3′ in FIG. 7a and FIG. 7b are connected to the sub-circuit subsequently whereas in FIG. 7c sub-circuit and current leads 3 are integrally formed.

So far, circuits have been shown comprising only a single sub-circuit 4. However, more complex assemblies and topologies are also possible, which will be described in the following.

A circuit can comprise several sub-circuits 4, which are connected in series and form one or more sub-circuit assemblies 5, 5′. Individual sub-circuits 4′ can be of equal diameter, stacked and then connected in series by electrically connecting (e.g., soldering) an exit connection area 6b of one sub-circuit 4. 4′ to an entry connection area 6a of the adjacent sub-circuit 4, 4′ (see FIG. 23). Additionally, it is possible to realize sub-circuits 4 with different diameters, so that they can be mounted concentrically (nested) and then connected in series by electrically connecting (e.g., soldering) the exit connection area 6b of one sub-circuit 4 to the entry connection area 6a of the adjacent sub-circuit 4 (see FIG. 8a-FIG. 12c). The innermost sub-circuit and the outermost sub-circuit of a circuit are connected to a current lead 3 each. In order to realize the inventive asymmetrical arrangement of the connection areas 6a, 6b, the connection areas 6a, 6b of the individual sub-circuits 4 are displaced in circumferential direction. A magnet comprising only one circuit with several sub-circuits assemblies 5, 5′ can be charged with only two current leads using the method described above with a reduced power required.

Variations of this concept are shown in FIG. 8b, FIG. 9a and FIG. 9b.

In case that one or more individual sub-circuits have a defect, e.g because already present in the original material or generated during realization of the sub-circuit, it is possible in all the embodiments already shown and those that follow to apply another conducting (preferably superconducting) material (preferably by soldering, but also by coating or other techniques) in parallel to the damaged/low performing zone, in order to repair or at least reduce its resistance. This allows the rest of the serially connected sub-circuits to be still charged. This is advantageous, because it allows to use the circuit with its serially connected sub-circuits (comprising the damaged/low performing sub-circuit) even if there are local damages/low performing parts of the sub-circuits.

The distances between the sub-circuits 4 of the circuit 10 shown in FIG. 8b are larger compared to those shown in FIG. 8a.

FIG. 9a and FIG. 9b show embodiments of inventive SC switch-free superconducting circuits 10 where the width of the paths of the sub-circuits 4 are “graded”, i.e. the path widths are different for the different sub-circuits 4. This allows adapting the circuit 10 to a change in the magnetic field, which would reduce the critical current in the sub-circuits 4, which are exposed to a higher magnetic field. As an example in FIG. 11 and FIG. 9b, the path of the central sub-circuit is wider because in a closed circuit 10, typically the innermost sub-circuit or material is exposed to the highest magnetic field. The graded design compensates for the decrease of the Ic of the superconductor due to its intrinsic sensitivity to a higher magnetic field. The embodiments shown in FIG. 9a and FIG. 9b differ in how the sub-circuits 4 are connected to each other: In FIG. 9a the multiple sub-circuits 4 of the sub-circuit assembly 5 and connections are integrally formed whereas in FIG. 9b separate sub-circuits 4 are provided which are connected subsequently using bridging elements 7 (superconducting or normal conducting).

In FIG. 9c a circuit 10 according to the invention is shown which comprises several serially connected nested sub-circuits 4, which are unequally spaced to each other. Here the space between the outer sub-circuits 4 is larger than that between the inner sub-circuits 4. The variation of the spaces between the sub-circuits 4 within a sub-circuit assembly 5 can be used to shape the magnetic field to be generated by the circuit 10.

FIG. 10 shows a SC switch-free superconducting circuit 10 according to the invention comprising two serially connected nested sub-circuits 4 wherein the first branches 1 of the sub-circuits 4 are oriented in opposing peripheral directions (i.e. direction from entry connection area to exit connection area of the respective sub-circuit runs clockwise or counterclockwise respectively viewed in paler plane of FIG. 10), thereby generating opposing magnetic fields. Thereby, modifications to the resulting magnetic field and properties of the circuit can be obtained, like for example reducing the external fringe field or localize it in some position in space, or reduce the inductance of the resulting circuit.

FIG. 11 shows an embodiment of a very space saving configuration of an inventive circuit in which multiple sub-circuits are nested within each other, with the branches of the sub-circuits differing from each other in both length and cross-section. The circuit includes alternating sub-circuits in which the shorter branch has the smaller path cross-section (and thus also has the smaller inductance) and sub-circui in which the longer branch has the smaller path cross-section. Since both the length of the branch and the path diameter have an influence on the inductance of the branch, in the latter case (longer branch with smaller cross section diamter) there is usually a smaller difference in inductance than in the neighs boring sub-circuits. Nevertheless, at least every second sub-circuit fulfills the conditions according to the invention. Furthermore, depending on the length ratio and thickness ratio in this embodiment, it may be that for every second sub-circuit, the branch with the smaller inductance is the longer path. This would result in adjacent sub-circuits generating magnetic fields in different directions analogue to the circuit shown in FIG. 10.

FIG. 12a, FIG. 12b and FIG. 12c show further geometries of SC switch-free superconducting circuits according to the invention with sub-circuit assemblies 5 having several serially connected nested sub-circuits 4.

Magnets according to the invention may comprise one or more circuits, i.e. a circuit-assembly. FIG. 13 for example shows an according circuit assembly with three circuits 10 (one outer circuit and two inner circuits), each circuit comprising one sub-circuit assembly. The two inner circuits are nested within the outer circuit. Each circuit is provided with a pair of current leads 3 and can be supplied with power separately.

In order to provide space and material saving embodiments the sub-circuits 4 are preferably arranged on a common carrier (e.g. leaf-shaped material or block of material with a superconducting coating). Such a circuit design can be produced e.g. by scratching a superconducting coated carrier (e.g. REBCO coating) and then scratching the coating with a tool or etching or laser patterning the surface. The tracks in the coating produced by these methods reduce or destroy the superconductivity in the track areas in order to isolate the individual sub-circuits 4 from each other. Alternatively, a bulk material can be deteriorated between the sub-circuits 4 or even completely cut through. The material between the branches 1, 2 of different sub-circuits 4 can even be totally removed.

Circuit Assemblies with Multiple Circuits—Nested Circuits

FIG. 13 shows a SC switch-free superconducting magnet according to the invention with several circuits 10 (one outer circuit and two inner circuits). The two inner circuits are nested within the outer circuit. Each circuit is provided with a pair of current leads 3 and can be supplied with power separately. The circuits 10 can be arranged on a common superconducting carrier.

### Side by Side Design of Several Circuits/Sub-Circuit Assemblies

FIG. 14 shows a SC switch-free superconducting circuit assembly according to the invention having several (here 6) circuits 10 provided side by side on a common carrier 8, e.g by using substrate patterning, masking, etching, etc. The configuration has the advantage of creating many circuits on the same support, which can be eventually bent or used in a more complicated device, to create a single unit with differently chargeable devices, to create different shapes of magnetic field, for example to generate a multi points shim device or a memory device. Each circuit 10 is provided with a pair of current leads 3, 3′ and can be supplied with power separately. One of the current leads 3 of each circuit is integrally formed with the circuit 10. The other current lead 3′ formed on the same carrier 8 but subsequently connected to the inner sub-circuit via a superconducting or normal conducting bridging element 7. This can be done e.g. by soldering a piece of HTS tape or similar or by direct deposition of an additional HTS layer or other materials.

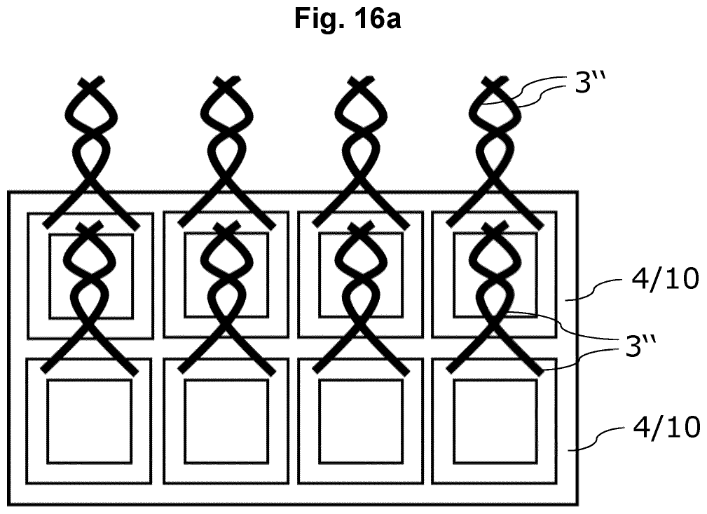

FIG. 15 also shows a SC switch-free superconducting circuit assembly according to the invention having several (here 8) circuits 10 provided side by side on a common carrier 8, wherein the circuits 10 each comprise only one single sub-circuit 4. No bridging element is required to connect the current leads 3 to the sub-circuit 4.

Alternatively, to current leads 3 being provided on the carrier 7, the sub-circuits 4 may be connected to current leads 3″ (superconducting or normal conducting) not integrated in the carrier 7. FIG. 16a for example shows twisted current leads 3″.

All the described circuits 10 can be connected with additional leads 9 (in particular soldered, superconducting or not) as shown in FIG. 26c and FIG. 26d, for example to check the status of the current flowing within the respective circuit 10. Thus, it is possible to feed a current and check the applied voltage. If the voltage is zero, the circuit 10 is not charged.

The additional leads 9 can also be used to unbalance the circuit by additional current feeding, such that a part of the circuit reaches the critical current before the other one, regardless of any geometrical or intrinsic unbalancing of the circuit, i.e. regardless of a difference in critical current or inductances between the first branch 1 and the second branch 2.

FIG. 16b shows twisted additional leads 9, FIG. 16c shows additional leads 9′ provided on the carrier 8 and connected in one piece with the sub-circuit 4. In FIG. 16c only one additional lead 9 is provided per circuit 10 because one of the current leads 3 can be used for status check.

As an extreme, both current leads 3 used for charging the circuit could be used for check. But this requires a more complicated circuitry and/or logic or programming.

So far, circuits have been described comprising only a single sub-circuit assembly with nested sub-circuits. In the following circuits are described comprising several sub-circuit assemblies: FIG. 16d and FIG. 16e show SC switch-free superconducting circuits 10′ having side by side arranged sub-circuit assemblies 5. The circuits 5 are serially connected to each other. Each sub-circuit assembly 5 comprises several nested sub-circuits 4. The sub-circuit assemblies 5 are provided on a common carrier 8 connected to each other via bridging elements 7. The series connection of the sub-circuit assemblies 5 is charged via only single pair of current leads 3. The current leads 3 are also provided on the carrier 8. In FIG. 16d the sub-circuit assemblies 5 of the circuit 10′ are of the same design whereas in FIG. 16e two different designs of sub-circuit assemblies are alternately arranged within the circuit 10′.

All described circuits 10, 10′ can be realized on flat, sheet-like carriers or on bent sheet-like carriers or other surfaces, like on tubes or bulk, or the carriers 8 can be bent before or after the circuit creation to have a final shape other than flat or round. As an example, FIG. 17 shows a circuit assembly with several circuits 10 as shown in FIG. 13 on a carrier 8 having a bent surface.

Alternatively, the circuits 10, 10′ shown before can be wound to a cylindrical magnet design with arbitrary base geometry (such as circle as shown in FIG. 18a, square, rectangular etc. or irregular) or to a 3D design (not shown). Preferably, the carrier 8 with the circuit 10, 10′ is spirally wound, thereby converting a side-by-side arrangement of sub-circuit assemblies 5 (with respect to the circuit 10, 10′) into a stacked arrangement of the sub-circuit assemblies 5 (within respect to the magnet generated from the circuit 10, 10′). FIG. 18b shows a spiral wound design with circular base geometry and offset ends of the circuit 10, 10′. This design results in a dipole magnetic field. FIG. 18c shows a spiral wound design with elongated base geometry. This design also results in a dipole magnetic field. FIG. 18d shows a spiral wound design with circular base geometry and ends adjacent to each other in the circumferential direction. This design results in a multipole magnetic field.

The circuits 10, 10′ and sub-circuit assemblies 5 of all before described magnets can be stacked in flat or curved form, so that the fields generated by the single circuits 10, 10′ superimpose, in particular add up. In FIG. 19 sub-circuits/sub-circuit assemblies are arranged on several bent carriers 8 and are stacked to form a cylindrical magnet. The stacked sub-circuits/sub circuit assemblies can be connected via bridging elements 7 or joints, which allows the magnet to be charged via only one pair or a few pairs of current leads. In FIG. 19 all sub-circuits/sub-circuit assemblies are connected in series. Thus, only one pair of current leads is required.

FIG. 20 shows the composition of a SC switch-free superconducting magnet according to the invention comprising several superimposed circuits 10′ and the corresponding magnetic field for different geometries. Multiple circuits 10′ with sub-circuit assemblies 5 already connected in series will be superimposed to create an superposition of the fields generated by the individual circuits 10′. This is done by offsetting several circuits 10′ in a z-direction (which represents the direction of the magnet axis) and shaping them into the desired magnet design. In this example, the offset circuits 10′ are wound into a cylindrical shape with a round or elongated base surface. By superimposing several circuits 10′, a larger and more complex distribution of the magnetic field can be obtained. FIG. 20 shows as an example that several circuits 10′ are superimposed in such a way that currents in opposite directions are superimposed in certain sections, so that the magnetic fields in these sections cancel each other out and a field results as if a uniform current were flowing over the entire length of the magnet (indicated by a bold arrow). The resulting magnet and thus the resulting magnetic field has a larger extension in z-direction than the individual circuits 10′. An according magnet design is also possible e.g. for circuit assemblies as shown in FIG. 14-FIG. 16c.

Stacked Design of Sub-Circuits-Assemblies with Nested Sub-Circuits

FIG. 21a shows a SC switch-free superconducting circuit 10″ according to the invention with several flat sheet-like sub-circuit assemblies 5 which are piled up to a stack. In the shown embodiment each sub-circuit assembly 5 comprises several sub-circuits 4 (multi sub-circuit circuits), here with radially nested sub-circuits 4 as described with respect to FIG. 8a-FIG. 9b. Nevertheless, stacked circuit designs are also possible for single sub-circuits 4. The sub-circuit assemblies 5 are serially connected via bridging elements 7, which are preferably positioned at the radially inner or the outer edge of the sub-circuit assemblies 5.

To cool down or to stabilize or reinforce the stack, an intermediate layer 11 can be inserted between some or even each sub-circuit assembly 5 as shown in FIG. 21b. The intermediate layer 11 can be made of metal (e.g. copper, steel sheets) and/or an electrically and/or thermally insulating material (e.g. Kapton).

### Tubular Circuit/Sub-Circuit Design

FIG. 22a-FIG. 22e show different embodiments of a tubular sub-circuit-design. In contrast to the flat sub-circuits 4 shown in FIG. 5a-FIG. 5c, the tubular sub-circuits 4′ form a cylinder. Although both, the tubular sub-circuits design as well as flat sub-circuit design may form e.g. circles, they differ in the orientation of the surface of the superconducting path of the sub-circuit 4, 4′. This becomes clearer if a carrier 8 is used on which the sub-circuits 4, 4′ are arranged: a carrier 8 for a tubular sub-circuit 4′ has a cylindrical/tubular shape whereas a carrier 8′ for flat sub-circuits 4 according to FIG. 5a-FIG. 5c has a flat/sheet-like shape. FIG. 22a shows a tubular sub-circuit 4′ with both current leads 3 aligned in the same direction and formed in one piece with the sub-circuit 4′. FIG. 22b shows a tubular sub-circuit 4′ with both current leads 3′ being aligned in the same direction but subsequently attached to the sub-circuit 4′ (e.g. soldered). FIG. 22c shows a tubular sub-circuit 4′ with current leads 3 aligned in opposite directions and formed in one piece with the sub-circuit 4′. FIG. 22d shows a tubular sub-circuit 4′ with current leads 3′ aligned in opposite directions, but subsequently attached to the sub-circuit 4′. FIG. 22e shows a tubular sub-circuit 4′ with current leads 3 aligned in opposite directions and formed in one piece with the sub-circuit 4′. The current leads 3 are positioned opposite resulting in branches 1, 2 of equal length. the different inductances L1, L2 of the branches 1, 2 are realizes by different path cross sections,

Nested Design of Sub-Circuits-Assemblies with Stacked Tubular Sub-Circuits

The concept of serialization of single tubular sub-circuits 4′ on a single tubular carrier 8′ is shown in FIG. 23 starting from the single sub-circuit 4′ shown in FIG. 22c: FIG. 23 shows a SC switch-free superconducting circuit 10 according to the invention comprising one sub-circuit assembly 5′ with stacked tubular sub-circuits 4′. The sub-circuits 4′ are connected in series via their connection areas 6a, 6b. The sub-circuits 4′ can be arranged on a tubular or cylindrical carrier 8′. In the example shown in FIG. 23 the stacked tubular sub-circuits 4′ are integrally formed (one piece) and form a hollow cylinder/tube, at whose axial ends current leads 3 are attached.

In addition, a grading in the width of the paths of the sub-circuits 4′ is shown in FIG. 23 so that the path widths of the sub-circuits 4′ at the axial ends are larger than those in the central positions of the sub-circuit assembly 5′. This design is particularly advantageous when using a REBCO-coated substrate where the superconductor carries much more current when the magnetic field is parallel to the surface (i.e. axially aligned) compared to a magnetic field with radial components. Since the magnetic field of a tubular magnet has radial components at its axial ends (i.e.: perpendicular to the surface of the tube), the critical current of the sub-circuits 4′ at the axial ends of the sub-circuit assembly 5′ is reduced. In the example shown in FIG. 23, sub-circuits with larger path widths are used at the axial ends to compensate for the loss of critical current due to the higher radial (perpendicular) magnetic field components.

Analogue to FIG. 21a where sub-circuit assemblies 5 with nested sub-circuits 4 are stacked, the sub-circuit assemblies 5′ with stacked tubular sub-circuits 4′ shown in FIG. 23 can be nested in order to increase the magnetic field generated by the magnet (FIG. 24). The nested sub-circuit assemblies 5′ are serially connected at their axial ends via bridging elements or joints and form a circuit 10″′. To cool down or to stabilize or reinforce the magnet, an intermediate layer (not shown) can be inserted between some or even each tubular sub-circuit assembly 5′ of the magnet. The intermediate layer can be made of metal (e.g. copper, steel sheets) and/or an electrically and/or thermally insulating material (e.g. Kapton).

FIG. 25a also shows a nested-sub-circuit-assembly-stacked-sub-circuit-design. Here, the sub-circuits 4′ are vertical ring-shaped bulks, stacked to form sub-circuit assemblies 5′, which were then arranged concentrically nested. By using bulk material, grading can be provided not only in axial direction but also in radial direction as shown in FIG. 25a. The sub-circuits and sub-circuit assemblies 5′ are serially connected via bridging elements 7.

FIG. 25b shows a similar design, but where no bridging elements are required. The circuit assembly shown in FIG. 25b comprising several nested sub-circuit assemblies 5′ with stacked sub-circuits 4′ is made in one piece from the bulk material. For this purpose, the material in the corresponding areas between the sub-circuits 4′ and/or the sub-circuit assemblies 5′ is removed to isolate the sub-circuits 4′ and/or the sub-circuit assemblies 5′ from each other. The free spaces can then be filled with non-superconducting material. Instead of filling the spaces between the nested sub-circuit assemblies 5′, intermediate layers (not shown) can be inserted between the tubular sub-circuit assemblies 5′ of the magnet. The intermediate layer can be made of metal (e.g. copper, steel sheets) and/or an electrically and/or thermally insulating material (e.g. Kapton).

### Shared Branch Design (Parallel Connection of Sub-Circuits)

Different sub-circuits 4 can have branches 1 in common, so that interactions between the two sub-circuits 4 occur. In this way, different methods can be realized to charge the system and to check they charge status or create interactions among the sub circuits for special purposes (e.g.: create oscillating circuits). FIG. 26a, FIG. 26b show as an example circuits 10″″ with two sub-circuits 4, each of which forms a loop I, II, the sub-circuits 4 sharing the first branch 1 and the current leads 3. The sub-circuits 4 connected in this way form a parallel connection.

The number of sub-circuits 4 that can be connected in this way (and thus have a common first branch 1) is not limited (unless there are technological/physical dimensioning problems). For simplicity, only a set of two sub-circuits 4 is described here.

If the two sub-circuits 4 have the same geometrical and physical properties, the current in the two sub-circuits 4 splits perfectly into two parts, creating the same field in both sub-circuits 4, but in opposite directions.

However, it's also possible that the sub-circuits 4 have different geometric and/or physical properties. In this case, a higher current can flow in one of the sub-circuits 4.

When considering very small sub-circuits, meaning circuits where one or more dimensions start to be of the order of magnitude of 1-100 the superconducting coherence length to penetration depth of the superconductor considered (typically the superconducting coherence lengths and penetration depths are of the order of 10⁻¹⁰ to 10⁻⁸ meter) at a certain point the classical description and phenomena are no longer valid and quantum mechanics must be considered to describe the behavior of the sub-circuits 4. The superconducting current is then described with a quantum mechanical wave. In this sense, the two sub-circuits 4 can only hold an integer number of fluxons each. Since the two sub-circuits 4 have the first branch 1 in common, the fluxon should enter one of the two sub-circuits 4 as soon as the supply current reaches the correct value to induce a fluxon into a single sub-circuit. However, if the two sub-circuits 4 are equal (have the same geometric and/or physical properties), the single fluxon cannot be assigned to one of the two sub-circuits 4 but has the same probability of remaining in both sub-circuits 4, so that it can be found with 50% probability in each of the two sub-circuits. There is a superposition of states.

To better explain: the state of the ith sub-circuit can be identified only with state of 0 fluxons, +1 fluxon (in this specific situation, + is defined as the field direction relating to the current circulating in the circuit using the “right hand rule”), −1 fluxon if the current is induced in the other sense (if we limit the voltage or the energy transmission to the level of inducing only 1 fluxon):
Ψᵢ={−1, 0, +1} with Ψᵢ being the wave function describing the possible states of the ith sub-circuit.

At the beginning, the two sub-circuits are without power, i.e. in the 0 state:
Ψ₁=|0> and Ψ₂=|0>

When the circuits 10″″ shown in FIG. 26a and FIG. 26b are charged, the possible states are:
{Ψ₁=0, Ψ₂=−1} and {Ψ₁=+1, Ψ₂=0} and the superposition of both.

In total, the state of the whole system can be described as:

Ψ=\sqrt{0.5}|0−1>+\sqrt{0.5}|+1 0>

The resulting magnetic field is thus given by the superposition of the two states provided that the interference between them exists as described by the overall system state.

When more than two sub-circuits are connected to the same branch, all of them share the energy of a single fluxon, meaning that the global state will be described by a weighted (by factors “aᵢ” related to the probability of that states) sum of states, due to the superposition of the states.

Since the sub-circuits 4 may not be identical or some interaction between the fields of the individual sub-circuits 4 (parts I and II) may be considered (due to the relative positions which can lead to some mutual inductance, or due to unwanted or artificially imposed differences, such as, as an extreme example, when the two sub-circuits 4 are bent over each other to achieve full coupling, or to realize some other architectures in order to have a controlled coupling, positive or negative), the overall state may have more complicated formulations, and in general (but not only) the a; coefficients may differ.

When considering very small sub-circuits where quantum mechanics must be considered, the operation to remove energy from the circuits 10″″ shown in FIG. 26a and FIG. 26b is not straightforward, as by simply applying the procedure discharging as described above a fluxon cannot be reliably removed for the following reasons. If the discharging procedure as described above like in classical (not quantum mechanical) situation, the possible states for the sub-circuits 4 are:
{Ψ1=0, Ψ2=0} and {Ψ1=+1, Ψ2=−1} for sub-circuit I and {Ψ1=+1, Ψ2=−1} and {Ψ1=0, Ψ2=0} for sub-circuit II.

Due to the superposition, in total, the state of the overall system (circuit 10″″) can be described as follows:

Ψ=√0.5|00>+√0.5|+1−1>

The probability to reach the initial state (energy 0) is as high as the probability to reach an even higher energy level of the system (2 fluxons).

In average, the energy is still corresponding to the presence of 1 fluxon.

The energy cannot be removed from the system by simply applying a classical discharging procedure.

To reset the state (discharging the circuit 10″″) (e.g.: reset the system to state 0, i.e.: 0 energy), and/or to control the charging and/or readout the state additional current leads 9, 9′ can be added. As an example, the following procedure can be used to reset the system (and readout the state):
1—a probe current Iprobe (<<the Ic of the circuit 10″″) is fed in one of the two second branches 2 (in the same sense of the supposed already present current circulating in the relative sub-circuit, i.e.: in state Ψ1=1 or Ψ2=−1, depending which sub-circuit is under test)
2—voltage is read by the same additional current leads 9, 9′: if the voltage raises from 0, it means that the state is 1 (or −1, depending which part is under test), because the currents are summed in the branch, overtaking the Ic
3—since now the state of one of the two coupled sub-circuits 4 is read, then the whole circuit state collapse in the state just read.

For example: if one of the sub-circuits 4 (e.g. loop I) is read and it is found to be in state 1, this means that the state of the enitre circuit 10″″ turns from state:

Ψ=√0.5|0−1>+√0.5|+1 0>

into the state

Ψ=|+1 0>

so the fluxon stays exactly in one of the two coupled sub-circuits 4, that is the loop I (the state is not more undetermined)
4—now it is possible to discharge the just identified charged sub-circuit (loop I) by feeding a current up to Ic between the additional branches 9, 9′ to cancel the circulating current in the corresponding sub-circuit (loop I).

In case other kinds of electromagnetic signals are used to charge/discharge the circuit, more complicated consideration must also be taken into account besides considerations concerning the current, as e.g. the quantization of the energy of the electromagnetic photon could eventually be considered to interact with the circuit.

### Current Supplies

The inventive SC-switch free magnet comprising a circuit according to the invention as described before can be charged using a standard power supply.

FIG. 27a shows a SC switch-free superconducting circuit conventionally connected to a power supply 12′. The power supply 12 comprises a power source which is connected to the current leads 3 of the circuit 10″′ directly via wire.

If the magnet is in a cryogenic environment CRYO, the current required to charge the magnet may be very high and a standard power supply 12′ cannot be used, since transferring high current from a room temperature environment RT to the cryogenic environment CRYO would bring a lot of heat into the cryogenic environment CRYO due to heat transfer and resistive heating which is to be avoided.

This problem can be solved by using a power supply 12 which comprises in addition to the power source an internal inductor 13 (having Nint turns) which is positioned in the cryogenic environment CRYO and an external inductor 14 (having Next turns) positioned outside the cryogenic environment CRYO as shown in FIG. 27b. The magnet (here with circuit 10″′) is charged from the internal inductor 13 via current leads 3 that are electrically connected to the internal inductor 13. By choosing an appropriate ration Next/Nint, in particular Next>Nint, it is possible to feed the magnet with a high current without physically transferring high currents through power lines from outside the room temperature environment RT to the cryogenic environment CRYO and still feeding the magnet via current leads.

For all embodiments described, the current leads can be superconducting or normal conducting, the current leads can be integrally formed with the sub-circuits or can be subsequently attached and connected via bridging elements (superconducting or normal conducting) or via joints to connection areas of sub-circuits. The series connection between the sub-circuits and/or between the circuits can be realized via bridging elements (superconducting or normal conducting) or via joints between connection areas of sub-circuits.

The connection between the sub-circuits 4, 4′ and the bridging 7 elements 7 can be realized by a superconducting or normal conducting joint, “joint” meaning a zone of passage between two elements, which electrically connect the two previously electrically separated elements.

In summary, a direct charging method (charging via current leads) and the corresponding circuit and production method are proposed with a superconducting circuit having asymmetrical design concerning the inductance of the branches. Due to the different inductances of the two branches 1, 2 an asymmetrical charging process will be realized according to the invention, resulting in a new possibility to make closed superconducting circuits chargeable by power supply. By providing different inductances for the first and the second branch the respective sub-circuit can be charged asymmetrically, since the current is primarily fed to the branch with the lower induction until the critical current of the one branch is reached and the current of the further current increase in step b is then completely fed into the other branch.

### LIST OF REFERENCE SIGNS

1 first branch
2 second branch
3 current leads/main current leads integrally formed with the path of the circuit
3′ current leads/main current leads subsequently attached to the path of the circuit
4 superconducting sub-circuit comprising a superconducting path (flat)
4′ superconducting sub-circuit comprising a superconducting path (tubular) sub-circuit assembly with nested sub-circuits
5′ sub-circuit assembly with stacked sub-circuits
6a entry connection area
6b exit connection area
7 bridging element
8 circuit carrier for flat sub-circuit design
8′ carrier for tubular sub-circuit design
9 additional leads
10 superconducting closed circuit (comprising a single sub-circuit/sub-circuit assembly)
10′ superconducting closed circuit (comprising several sub-circuits/sub-circuit assemblies arranged side by side)
10″ superconducting closed circuit (comprising a several sub-circuit/sub-circuit assemblies arranged stacked)
10″′ superconducting closed circuit (comprising a several tubular sub-circuit/sub-circuit assemblies arranged nested)
10″″ superconducting closed circuit (comprising a several sub-circuits connected in parallel with shared first branch)
11 intermediate layer
12 power supply located partially in the cryogenic environment and comprising an internal inductor
12′ power supply with conventional connection to the circuit via wire only
101 first branch (state of the art)
102 second branch (state of the art)
103 current leads (state of the art)
104 sub-circuit (state of the art)
13 internal conductor
14 external conductor
CRYO cryogenic environment
RT room temperature environment
Iin supply current
Ic1 critical current of the first branch (first critical current)
Ic2 critical current of the second branch (second critical current)
Ic critical current of branches having the same critical currents
I1 current flowing through the first branch (first partial current)
I2 current flowing through the second branch (second partial current)
I0 current flowing in the circuit prior to charging/discharging process
Icircuit current flowing in the circuit after charging/discharging process

### LIST OF CITED REFERENCES

U.S. Pat. No. 3,546,541
U.S. Pat. No. 8,965,468B2
US2019172619A1
U.S. Pat. No. 4,467,303
EP2511917A1
U.S. Pat. No. 5,633,588A1
U.S. Pat. No. 8,228,148B2
US20160380526A1
Mark D Ainslie, Mykhaylo Filipenko
“Bulk superconductors: a roadmap to applications”, Par. 4: “Ultra-light superconducting rotating machines for next-generation transport & power applications” Supercond. Sci. Technol. 31 (2018) 103501
U.S. Pat. No. 6,762,664B2

1. Method for charging and/or discharging and/or reversing the charge of a superconducting-switch-free superconductively closed circuit (10; 10′; 10″; 10″′; 10″″) with
at least one superconducting sub-circuit (4; 4′) with a closed superconducting path, at least one sub-circuit (4; 4′) comprising an entry connection area (6a) for feeding current into the sub-circuit (4; 4′) and an exit connection area (6b) for feeding current out of the sub-circuit (4; 4′), wherein the connection areas (6a, 6b) divide the corresponding sub-circuit (4; 4′) into a first branch (1) and at least a second branch (2), the first branch (1) having a first inductance L1 and a first critical current Ic1 and the second branch (2) having a second inductance L2 and a second critical current Ic2, wherein the positions of the connection areas (6a, 6b) and/or the geometry of the branches (1, 2) and/or the cross sections of the branches (1, 2) have been chosen such that the first inductance L1 of the first branch (1) is lower than the second inductance L2 of the second branch (2),
currents leads (3; 3′) for connecting the circuit to a power supply (12, 12′),
wherein the method comprises:
Electrically connecting one entry connection area (6a) and one exit connection area (6b) of the circuit to the power supply (12) via the current leads (3; 3′),
Modifying an initial current I0 (I0≥0) within the superconducting circuit (10; 10′; 10″; 10″′; 10″″) by feeding a supply current Iin into the circuit (10; 10′; 10″; 10″′; 10″″) with the following steps:
(a) Increasing the supply current Iin until a first partial current, which passes through one of the two branches (1, 2), reaches the critical current of that branch,
(b) Further increasing the supply current Iin to Δa resulting in a second partial current, which passes into the other branch,
(c) Reducing the supply current Iin to OA, resulting in a remanent circuit current Icircuit within the circuit (10; 10′; 10″; 10″′; 10″″),
characterized in that for charging the circuit (10; 10′; 10″; 10″′; 10″″) (Icircuit>I0), in step (b) the supply current Iin is increased to Δa, wherein:
Δa/Ic1>0
if h*k<1: (k+1)<Δa/Ic1≤(h+1)/h
if h*k>1: (k+1)/(h*k)<Δa/Ic1≤(h+1)/h
with 0<k=L1/L2<1 and h=Ic1/Ic2>0 and h*k≠1.

2. Method for charging and/or discharging and/or reversing the charge of a superconducting-switch-free superconductively closed circuit (10; 10′; 10″; 10″′; 10″″) with
at least one superconducting sub-circuit (4; 4′) with a closed superconducting path, at least one sub-circuit (4; 4′) comprising an entry connection area (6a) for feeding current into the sub-circuit (4; 4′) and an exit connection area (6b) for feeding current out of the sub-circuit (4; 4′), wherein the connection areas (6a, 6b) divide the corresponding sub-circuit (4; 4′) into a first branch (1) and at least a second branch (2), the first branch (1) having a first inductance L1 and a first critical current Ic1 and the second branch (2) having a second inductance L2 and a second critical current Ic2, wherein the positions of the connection areas (6a, 6b) and/or the geometry of the branches (1, 2) and/or the cross sections of the branches (1, 2) have been chosen such that the first inductance L1 of the first branch (1) is lower than the second inductance L2 of the second branch (2),
currents leads (3; 3′) for connecting the circuit to a power supply (12, 12′),
wherein the method comprises:
Electrically connecting one entry connection area (6a) and one exit connection area (6b) of the circuit to the power supply (12) via the current leads (3; 3′),
Choosing the positions of the connection areas (6a, 6b) and/or the geometry of the branches (1, 2) and/or the cross sections of the branches (1, 2) such that the first inductance L1 of the first branch (1) is lower than the second inductance L2 of the second branch (2),
Modifying an initial current I0 (I0≥0) within the superconducting circuit (10; 10′; 10″; 10″′; 10″″) by feeding a supply current Iin into the circuit (10; 10′; 10″; 10″′; 10″″) with the following steps:
(d) Increasing the supply current Iin until a first partial current, which passes through one of the two branches (1, 2), reaches the critical current of that branch,
(e) Further increasing the supply current Iin to Δa resulting in a second partial current, which passes into the other branch,
(f) Reducing the supply current Iin to OA, resulting in a remanent circuit current Icircuit within the circuit (10; 10′; 10″; 10″′; 10″″),
characterized in that for at least partially discharging the circuit (10; 10′; 10″; 10″′; 10″″) or reversing the polarity of the current circulating in the circuit (10; 10′; 10″; 10″′; 10″″), the supply current Iin is increased to Δb with a polarity opposite to the polarity of Δa in step (b), wherein:
Δb/Ic1>0
if h*k<1: 2*(k+1)−Δa/Ic1<Δb/Ic1≤(h+1)/h
if h*k>1: 2*(k+1)/(h*k)−Δa/Ic1<Δb/Ic1≤(h+1)/h
with k=L1/L2 and h=Ic1/Ic2.

3. Method according to claim 1 to 2, wherein the circuit (10″″) comprises at least two sub-circuits (4) having the first branch (1) in common, wherein the circuit current Icircuit being shared between the two or more sub-circuits (4) by either classically splitting the current into the two sub-circuits (4) or quantically by superposition of the possible states Ψ₁, Ψ₂ the two or more sub-circuits (4), with Ψ₁=|0> or |1>, Ψ₂=|−1> or |0>,
resulting in a system state Ψ_{system}=a I0 −1>+b|1 0>, where a and b depend upon the geometrical and physical properties of the two sub-circuits (4).
characterized in
that for discharging the circuit (10″″), prior to increasing the supply current:
a probe current Iprobe is temporarily fed in the second branch (2) of one of the sub-circuits (4) which is the sub-circuit under investigation via additional leads (9), wherein Iprobe is smaller than the critical current of the sub-circuit under investigation;
the voltage between the additional leads (9) is measured during feeding of the probe current Iprobe;
if a voltage unequal zero is detected, determine the initial current I0 (classically) or the state (quantum-mechanically) of the sub-circuit under investigation, thereby determining the state of the whole system.

4. Method according to one of claims 1 to 3, characterized in that the supply current is fed to the circuit (10″′) using a current power supply (12) comprising an internal inductor (13) positioned in a cryogenic environment (CRYO) together with the superconducting circuit (10″′) and a further inductor (14), which is preferably positioned outside the cryogenic environment (CRYO), wherein the current leads (3) are electrically connected to the internal inductor (13) and current is induced from the further inductor (14) to the internal inductor (13) and fed to the superconducting circuit (10″′) via the current leads (3).

5. Method according to one of the preceding claims, characterized in that the supply current Iin that is fed into the circuit (10; 10′; 10″; 10″′; 10″″) is changed by using at least one of: step current ramps and/or current versus time ramps and/or high frequency pulses and/or wave packets/electromagnetic waves.

6. Method according to one of the preceding claims, characterized in that prior to feeding the supply current Iin, at least one sub-circuit (4; 4′) of the circuit (10; 10′; 10″; 10″′; 10″″), preferably the whole circuit (10; 10′; 10″; 10″′; 10″″), is pre-heated in order to reduce the critical currents Ic1, Ic2.

7. Superconducting-switch-free superconductively closed circuit (10; 10′; 10″; 10″′; 10″″) for use with a method according to one of the preceding claims, the circuit comprising:
at least one superconducting sub-circuit (4; 4′) with a superconducting path,
at least one sub-circuit (4; 4′) comprising an entry connection area (6a) for feeding current into the sub-circuit (4; 4′) and an exit connection area (6b) for feeding current out of the sub-circuit (4; 4′), wherein the connection areas (6a, 6b) divide the corresponding sub-circuit (4; 4′) in to a first branch (1) and at least a second branch (2), the first branch (1) having a first inductance L1 and a first critical current Ic1 and the second branch having a second inductance L2, and
currents leads (3, 3′) for connecting the circuit (10; 10′; 10″; 10″′; 10″″) to a power supply (12, 12′),
characterized in
that the positions of the connection areas (6a, 6b) and/or the geometry of the branches (1, 2) and/or the cross sections of the branches (1, 2) being chosen such that the first inductance L1 of the first branch (1) is lower than the second inductance L2 of the second branch (2).

8. Superconducting circuit (10; 10′; 10″; 10″′) according to claim 7 characterized in that the second branch (2) has a second critical current Ic2, which is equal to the first critical current Ic1.

9. Superconducting circuit (10; 10′; 10″; 10″′) according to one of the claims 7 to 8, characterized in that the circuit (10′; 10″; 10″′) comprises more than one sub-circuit (4; 4′), wherein the exit connection area (6b) of one sub-circuit (4; 4′) is connected to the entry connection (6a) area of the other sub-circuit (4; 4′), and wherein one entry connection area (6a) and one exit connection area (ab) of the circuit (10′; 10″; 10″′) is connected to the current leads (3).

10. Superconducting circuit (10) according to claim 9, characterized in that the position of the current leads (3) and/or the geometry of the branches (1, 2) are chosen such, that the path of the first branch (1) of at least one of the sub-circuits (4), the path extending from the entry connection area (6a) to the exit connection area (6b) of the respective sub-circuit (4), runs at least partially in opposite direction than the path of the first branch (1) of at least one other sub-circuit (4).

11. Superconducting circuit (10; 10′; 10″; 10″′) according to claim 9 or 10, characterized in that several sub-circuits (4; 4′) are nested or stacked to form a sub-circuit assembly (5; 5′).

12. Superconducting circuit (10′; 10″; 10″′) according to claim 11, characterized in that several sub-circuit assemblies (5; 5′) are provided, the sub-circuit assemblies being arranged nested, offset or side by side.

13. Superconducting circuit (10; 10′; 10″; 10″′) according to one of the claims 9 to 12, characterized in that the critical currents of the sub-circuits and/or the distances of the sub-circuits with respect to each other change in axial and/or radial direction.

14. Superconducting circuit (10″″) according to one of the claims 7 to 8, characterized in that the circuit (10″″) comprises more than one sub-circuit (4), wherein at least two sub-circuits (4) have their first branch (1) in common, such that the initial current I0 being shared between the two sub-circuits (4) by either classically splitting the initial current I0 into the two sub-circuits (4) or quantum-mechanically by superposition of the possible states Ψ₁, Ψ₂ of the two sub-circuits (4), with Ψ₁=|0> or |1>, Ψ₂=|−1> or |0>, resulting in a system state Ψ_{system}=a|0−1>+b|1 0>, where a and b depend upon the geometrical and physical properties of the two sub-circuits (4).

15. Superconducting circuit (10″″) according to claim 14, characterized in that additional current leads (9) are connected to at least one of the branches (1, 2), in particular for checking the current flow within the respective branch or to charge or discharge the circuit (10″″) in a controlled way.

16. Superconducting circuit (10, 10″′) according to one of the claims 7 to 15, characterized in that the sub-circuits (4′) are tubular.

17. Superconducting circuit (10; 10′; 10″; 10″′; 10″″) according to one of the claims 11 to 16, characterized in that the sub-circuits (4; 4′) of a sub-circuit assembly (5; 5′), in particular of the whole circuit (10; 10′; 10″; 10″′; 10″″), are a single piece of a superconductive material, in particular made from a superconductive layer or a superconducting bulk material, wherein the sub-circuits (4; 4′) are superconductively insulated from each other except for their connection areas.

18. Superconducting magnet comprising at least one superconducting circuit (10; 10′; 10″; 10″′; 10″″) according to one of the claims 7 to 17, in particular for use in magnetic resonance applications.

19. Method for producing a superconducting circuit (10; 10′; 10″; 10″′; 10″″) according to one of the claims 7 to 17, the method comprising:
providing a circuit carrier (8; 8′),
creating a superconductive path on the circuit carrier (8; 8′), the path forming at least one superconducting sub-circuit (4; 4′),
providing connection areas (6a, 6b) at the sub-circuit (4; 4′) such the superconducting sub-circuit (4; 4′) is divided at least into branches (1, 2) having different inductances L1, L2, wherein the connection areas (6a, 6b) of each sub-circuit (4; 4′) are electrically connected to connection areas (6a, 6b) of other sub-circuits (4; 4′) or to current leads (3; 3′).

20. Method according to claim 19, characterized in that the path is created by directly drawing superconducting material onto the surface of the circuit carrier (8; 8′).
